(19) United States
(12) Patent Application Publication
(10) Pub. No.: US 2013/0262686 A1
(43) Pub. Date: Oct. 3, 2013

(54) METHOD FOR ORGANIZING A COLLABORATIVE EVENT AND SYSTEM EMPLOYING SAME

(71) Applicant: SMART TECHNOLOGIES ULC, Calgary (CA)

(72) Inventors: DOUGLAS BLAIR HILL, Calgary (CA); LUQING WANG, Calgary (CA); ANDREW LEUNG, Calgary (CA); PAUL VANETTI, Calgary (CA); DOUGLAS JOHN BROWN, Calgary (CA); MIN XIN, Calgary (CA); ASHRAF BADAWI, Calgary (CA); GISELLE GONCALVES, Calgary (CA); DAVID POPOVICH, Calgary (CA); EDWARD TSE, Calgary (CA); MICHAEL BOYLE, Calgary (CA)

(73) Assignee: SMART TECHNOLOGIES ULC, Calgary (CA)

(21) Appl. No.: 13/753,217

(22) Filed: Jan. 29, 2013

Related U.S. Application Data
(60) Provisional application No. 61/617,006, filed on Mar. 28, 2012.

(51) Int. Cl. H04L 29/06

(52) U.S. Cl. CPC H04L 65/1069
USPC 709/228

(57) ABSTRACT

A method of establishing a collaborative event comprises creating an event session having an event identifier and setting up a wireless network to which one or more participant computing devices can connect having a network identifier associated with said event identifier.

### CROSS-REFERENCE TO RELATED APPLICATION

This application claims the benefit of U.S. Provisional Application No. 61/617,006 to Hill et al. filed on Mar. 28, 2012, entitled “Method for Organizing a Collaborative Event and System Employing Same”, the entire disclosure of which is incorporated herein by reference.

### FIELD OF THE INVENTION

The present invention relates generally to collaboration systems and in particular, to a method for organizing a collaborative event and to a collaboration system employing the same.

### BACKGROUND OF THE INVENTION

Conferencing and other event management systems, such as Microsoft® Live Meeting, Citrix® GoToMeeting®, SMART Bridgit™, and the like are well known. These systems allow participants at different geographical locations to participate in a collaborative session using computing devices, by sharing content, such as, screen images and files, or a common page on an interactive whiteboard (IWB). For example, the SMART Bridgit™ version 4.2 conferencing system offered by SMART Technologies ULC of Calgary, Alberta, Canada, assignee of the subject application comprises one or more servers and clients, and provides plug-ins for event scheduling programs, such as, Microsoft Exchange® or Microsoft Outlook®. An event may be scheduled in Microsoft Outlook® via a SMART Bridgit™ plug-in on a participant's computing device, by assigning a name, a start time and an end time to the event. Using a SMART Bridgit™ client program, a user may create an event session on the SMART Bridgit™ server to start an ad-hoc event. Other participants may join the event session using the SMART Bridgit™ client program running on their computing devices by entering the event name and any required password. In addition to sharing content, participants can annotate shared screen images by injecting digital ink thereon using a computer mouse, a touch screen, or an interactive whiteboard.

Unfortunately, these known systems have several drawbacks. For example, in order to join an event, a participant's computing device is required to have an appropriate client program installed thereon, otherwise the user is required to download and install the client program before being able to join the event. The user must then run the client program to connect to a host device or network in order to join the event or collaboration session. Accordingly, the participant is required to have knowledge of the particular uniform resource locator (URL) for the client program to be downloaded, including any user access credentials. In addition, the participant is required to have knowledge of the URL of the server hosting the event including user access credentials. For a participant connecting remotely or wirelessly, knowledge of the network settings for the participant's computing device, such as the static IP address, DHCP server address, network service set identifier (SSID) and network key, is typically required. Accordingly, these systems demand the participant to have a certain level of understanding of computer networks, including knowledge of specific network details that may not be readily available to the participant. Inevitably, the participant is often forced to seek technical support, and oftentimes the participant is precluded from participating in the event due to the inability to connect to the network or join the session.

Improvements are therefore generally desired. It is therefore an object to provide a novel method for organizing a collaborative event and a novel collaboration system employing the same.

### SUMMARY OF THE INVENTION

Accordingly, in one aspect there is provided a method of establishing a collaborative event, said method comprising creating an event session having an event identifier; and setting up a wireless network to which one or more participant computing devices can connect having a network identifier associated with said event identifier.

In one embodiment, the method further comprises, prior to creating the event session, collecting event information relating to the collaborative event. The event information may comprise the event identifier and an event password. The method may further comprises communicatively coupling at least one participant computing device to the wireless network. Upon coupling of the at least one participant computing device to the wireless network, the participant computing device may be automatically caused to join the event session. The method may further comprise providing the event identifier and the event password to the at least one participant computing device prior to the coupling of the at least one participant computing device to the wireless network. The providing may comprise sending an electronic invitation message comprising the event identifier and the event password to the at least one participant computing device and/or displaying the event identifier and the event password on a display at an event site of the collaborative event. In one form, the display may an interactive whiteboard.

In one form, the network identifier is derived from the event identifier by string manipulation. The string manipulation may comprise concatenating at least a portion of the event identifier with additional characters.

In one embodiment, the method further comprises setting a network key of the wireless network as the event password.

According to another aspect, there is provided a non-transitory computer-readable medium having embodied thereon a computer program for a collaborative event, said program comprising instructions which, when executed by processing structure, carry out the steps of creating an event session having an event identifier; and setting up a wireless network to which one or more participant computing devices can connect having a network identifier associated with said event identifier.

According to yet another aspect, there is provided an interactive whiteboard configured to communicate with processing structure conducting a collaborative event, said interactive whiteboard further being configured, during said collaborative event, to display an event identifier of an event session of said collaborative event; an event password of said event session; and content shared between said processing structure and at least one participant computing device communicatively coupled to said event session.

According to yet another aspect, there is provided a computerized method comprising receiving, from a user computing device, information concerning the location of content to be shared; intercepting a network request from another user computing device; and redirecting the intercepted network request to the location of said content.

According to yet another aspect, there is provided a computerized method comprising determining member participant computing devices of each group of participant computing devices; intercepting a network request from one of said participant computing devices; determining the group to which the participant computing device that sent the intercepted network request belongs; and redirecting said the intercepted network request to a location assigned to said group.

According to yet another aspect, there is provided a method comprising initiating, by a host computing device, a wireless network; and broadcasting, by the host computing device, a signal comprising the identity of said wireless network and a password for accessing said wireless network.

According to yet another aspect, there is provided an apparatus comprising processing structure; wireless networking component functionally coupled to said processing structure, wherein said processing structure executes code that causes said apparatus at least to determine whether a wireless network having a predefined feature exists; and start a wireless network if the wireless network having a predefined feature is not detected.

According to yet another aspect, there is provided a method comprising initiating, by a host computing device, a first wireless network; detecting a signal broadcasted by another computing device, said signal comprising a timestamp indicating the starting time of a second wireless network; comparing said timestamp with the start time of said first wireless network; and terminating said first wireless network if said timestamp indicates a time earlier than the start time of said first wireless network.

According to yet another aspect, there is provided a non-transitory computer readable medium embodying executable code, that when executed by a computing device causes the computing device to perform the steps of receiving, from a user computing device, information concerning the location of content to be shared; intercepting a network request from another user computing device; and redirecting the intercepted network request to the location of said content.

According to yet another aspect, there is provided a non-transitory computer readable medium embodying executable code, that when executed by a computing device causes the computing device to perform the steps of determining member participant computing devices of each group of participant computing devices; intercepting a network request from one of said participant computing devices; determining the group to which the participant computing device that sent the intercepted network request belongs; and redirecting said the intercepted network request to a location assigned to said group.

### BRIEF DESCRIPTION OF THE DRAWINGS

Embodiments will now be described more fully with reference to the accompanying drawings in which:

FIG. 1 is a schematic diagram of a collaboration system;

FIG. 2 is a block diagram of a software architecture of an event computing device forming part of the collaboration system of FIG. 1;

FIG. 3 is a block diagram of a software architecture of a participant computing device forming part of the collaboration system of FIG. 1;

FIG. 4 is a block diagram of a software architecture of another participant computing device forming part of the collaboration system of FIG. 1;

FIG. 5A is a flowchart showing steps of an event scheduling request process used by the collaboration system of FIG. 1;

FIG. 5B is a flowchart showing steps of an event scheduling process used by the collaboration system of FIG. 1;

FIG. 6 is a flowchart showing steps of an event start process used by the collaboration system of FIG. 1;

FIG. 7 is a flowchart showing steps of an event start preparation process, forming part of the event start process of FIG. 6;

FIG. 8 is a flowchart showing steps of a participant computing device connection process used by the collaboration system of FIG. 1;

FIG. 9 is a flowchart showing steps of an event end process used by the collaboration system of FIG. 1;

FIGS. 10 to 14 are exemplary graphical user interfaces presented by the collaboration system of FIG. 1 during scheduling, starting and joining of an event;

FIG. 15 is a graphical user interface presented by an event management module of an alternative collaboration system;

FIG. 16 is a flowchart showing steps of an alternative event join process;

FIG. 17 is a graphical user interface presented by an event client during the event join process of FIG. 16;

FIG. 18 shows the graphical user interface of FIG. 17 including a wireless network dialogue box;

FIG. 19 is a schematic diagram of another embodiment of a collaboration system;

FIG. 20 is a block diagram of a software architecture of an event computing device forming part of the collaboration system of FIG. 19;

FIG. 21 is a block diagram of a software architecture of a network management server forming part of the collaboration system of FIG. 19;

FIG. 22 is a flowchart showing steps of an event start preparation process used by the collaboration system of FIG. 19;

FIG. 23 is a graphical user interface presented by a web browser running on a participant computing device forming part of the collaboration system of FIG. 19, after the participant computing device has joined an event;

FIG. 24 is a schematic diagram of yet another embodiment of a collaboration system;

FIG. 25 is a block diagram of a software architecture of a participant computing device forming part of the collaboration system of FIG. 24;

FIG. 26 is a block diagram of a software architecture of an event computing device forming part of the collaboration system of FIG. 24;

FIG. 27 is a flowchart showing steps of a private network establishment process used by the collaboration system of FIG. 24;

FIG. 28 is a schematic diagram of still yet another embodiment of a collaboration system;

FIG. 29 is a block diagram of a software architecture of an event computing device forming part of the collaboration system of FIG. 28;

FIG. 30 shows an exemplary process of joining a registered computing device into an event session;

FIG. 31 shows an image presented on the display of an event computing device;

FIG. 32 shows a web browser displaying the details of participant computing devices;

FIG. 33 shows a portable participant computing device in the event session displaying a user interface providing details of participant computing devices;

FIG. 34 shows an exemplary sequence diagram for sharing a web URL with other users;

FIG. 35 shows an exemplary authorized user's web browser;

FIG. 36 is a flowchart showing steps of dividing users into groups;

FIG. 37 is an exemplary sequence diagram for sharing a web URL with users in a user group;

FIGS. 38 to 40 show an example of dividing users to groups;

FIG. 41 shows a schematic diagram of a collaboration system according to an alternative embodiment;

FIG. 42 is a flowchart showing steps performed during an event computing device start up process;

FIG. 43 shows an exemplary structure of a beacon signal frame;

FIG. 44 is an exemplary sequence diagram illustrating an event computing device joining a signature wireless network created by another event computing device;

FIG. 45 illustrates an exemplary dialog displayed by the event computing device to enable a user to select a signature wireless network;

FIG. 46 is a flowchart showing steps for solving a race condition;

FIG. 47 is an exemplary sequence diagram of a race condition being solved; and

FIG. 48 is a flowchart showing steps of a failed signature wireless network recovery process.

### DETAILED DESCRIPTION OF THE EMBODIMENTS

A collaboration system and a method for joining a collaboration session in the collaboration system are described herein. The collaboration system comprises a plurality of computing devices in communication with each other over at least one network when a collaboration session has been established. Each of the computing devices is configured to share content with the other computing devices, with the shared content being displayed on other computing devices. One or more of the computing devices is configured to accept input annotations made on displayed shared content, and to share the input annotations with other computing devices over the at least one network.

The computing devices may take a variety of forms such as for example personal computers, laptop computers, tablet computers, computer servers, computerized kiosks, personal digital assistants (PDAs), cellular phones, smartphones, and the like. Regardless of the specific form, each computing device typically comprises, for example, a processing unit, system memory (volatile and/or non-volatile memory), other non-removable memory and/or optional removable memory (e.g. a hard disk drive, RAM, ROM, EEPROM, CD-ROM, DVD, flash memory, etc.), input/output devices (e.g. a display screen, a mouse, a keyboard, one or more buttons, a touchpad, a touch screen, an interactive board, etc.), and a system bus coupling the various components to the processing unit. The display screen can present various types of information to the user such as graphical and textual displays, and may also function as an input mechanism that accepts touch input made thereon using a pointer such as for example a pen tool, an eraser tool or a finger. One or more of the computing devices may also comprise networking capabilities using Ethernet, WiFi, and/or other network format, to enable connection to shared or remote drives, one or more networked computers, or other networked devices. One or more computing devices may be physically located in a collaboration room or other common location while other computing devices may be located at different geographical locations.

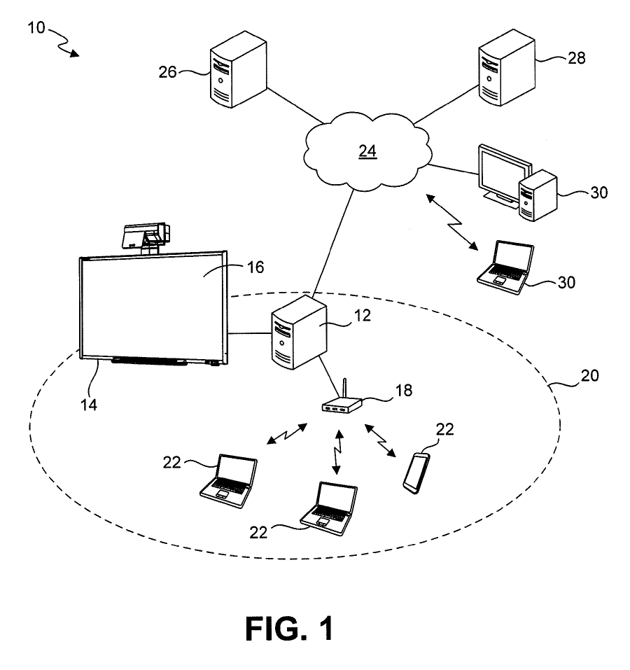

Turning now to FIG. 1, a collaboration system is shown and is generally identified by reference numeral 10. The collaboration system 10 comprises at least one event computing device 12 that is physically located at an event site, such as for example a meeting room. An interactive whiteboard (IWB) 14 comprising an interactive surface 16, such as the Model 885ix interactive whiteboard sold by SMART Technologies ULC, is connected to the event computing device 12. The IWB 14 is configured to display event content and to receive touch input applied thereon. A wireless network device 18 is coupled to the event computing device 12, and is configured to provide a wireless network 20 over which participant computing devices 22 communicate. Although three participant computing devices 22 are shown, those of skill in the art will appreciate that this is simply for ease of illustration. More or fewer participant computing devices 22 may communicate over the wireless network 20. The event computing device 12 is configured to control the wireless network device 18 and to manage the wireless network 20.

In this embodiment, the wireless network 20 is assigned a wireless network service set identifier (SSID), and communications via the wireless network device 18 are encrypted using a security protocol, such as Wi-Fi Protected Access II (WPA2) protocol with a customizable network key. In order to participate in an event, a participant computing device 22 is required to identify the SSID of the wireless network 20 and send a corresponding network key thereto to communicatively couple the participant computing device 22 to the wireless network 20.

Event computing device 12 is also communicatively coupled to a network 24 over either a wired connection, such as Ethernet, or a wireless connection, such as Wi-Fi™, Bluetooth™ etc. The network 24 may be a local area network (LAN) within an organization, a cellular network, the Internet, or a combination of different networks. A plurality of server computing devices, namely an event server 26 and a scheduling server 28, and one or more participant computing devices 30 also are in communication with the network 24. The server computing devices 26 and 28 and participant computing devices 30 may communicate with the networks 18 and 24 over a wireless connection, a wired connection or a combined wireless/wired connection.

Event server 26 is configured to manage event sessions by receiving and synthesizing audio, video and data streams, respectively, from event participants, and broadcasts the synthesized streams to the event participants. In this embodiment, the event server 26 is a SMART Bridgit™ server offered by SMART Technologies ULC. The scheduling server 28 is configured to manage the schedule of events or sessions. In this embodiment, the scheduling server 28 is a Microsoft Exchange Server® provided by Microsoft Corporation of Redmond, Wash., U.S.A.

The event computing device 12 and the participant computing devices 22 and 30 each have installed thereon an operating system (OS) such as, for example, Microsoft Windows®, Linux®, Mac OS X® etc. The event computing device 12 and the participant computing devices 22 and 30 may all be used to schedule an event. In this embodiment, the event computing device 12 may also be used to start or join an event session, and to control the wireless network device 18 in order to enable participant computing devices 22 to join the event session via the wireless network 20. The participant computing devices 30 may also be used to join the event session via the network 24.

The event computing device 12 and the participant computing devices 22 and 30 are configured to share content during an event, which may for example be a meeting, a conference or a collaboration session. The content may be a common screen image, for example. The shared content can be modified by event participants through annotation. For example, the shared content may be displayed on the IWB 14 connected to the event computing device 12, and event participants at the event site can modify the shared content through touch input applied to the IWB 14. The touch input may take the form of, for example, a mouse event or digital ink. Participants who join the event can also modify the shared content using input devices associated with their respective participant computing devices 22 and 30. These input devices may be, for example, computer mice, keyboards, touch screens, tablets, digital pens etc.

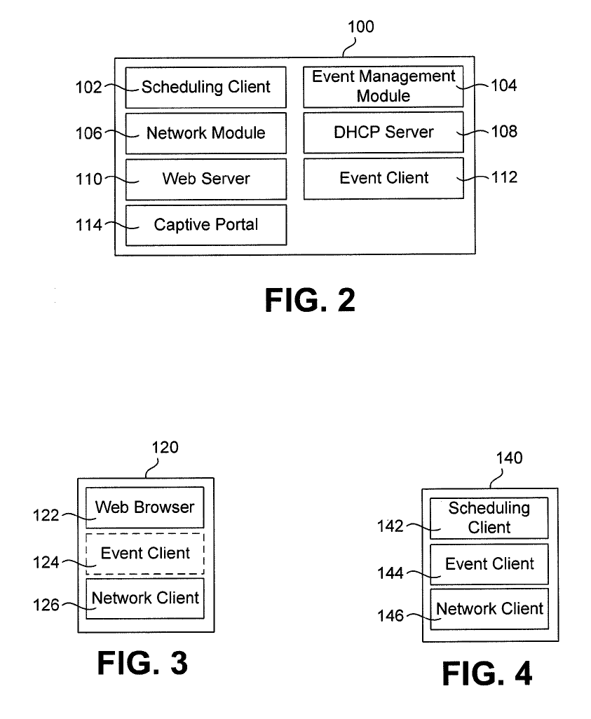

FIG. 2 shows the software architecture 100 of the event computing device 12. Software architecture 100 comprises a scheduling client 102, such as, Microsoft Outlook® having a SMART Bridgit™ plug-in, an event management module 104, such as, SMART Meeting Pro™ Premium, a network module 106, a Dynamic Host Configuration Protocol (DHCP) server 108, a web server 110, an event client 112, and a captive portal module 114.

The scheduling client 102 is in communication with the scheduling server 28 via network 24, and is configured to set up and update the event schedule of the event computing device 12, and to notify the event management module 104 to start an event session at a scheduled starting time. The event management module 104 is in communication with the event server 26 via the network, and is configured to create an event session thereon, and to exchange shared data therewith, such as for example shared screen images or annotations. The event management module 104 is also in communication with the network module 106, and is configured to set up a wireless network 20 using an event name and an event password.

The network module 106 is configured to control the wireless network device 18 for setting up the wireless network 20, as requested by the event management module 104, and to manage wireless connections of the participant computing devices 22. The DHCP server 108 is configured to assign an IP address to each participant computing device 22 when it connects to the wireless network 20. The web server 110 comprises a web portal interface with a download link or uniform resource locator (URL) of the event client 112 that is stored in the event computing device 12. The captive portal 114 is configured to monitor network-related requests sent from participant computing devices 22, and to redirect at least some of the network-related requests to the web server 110.

FIG. 3 shows the software architecture 120 of one of the participant computing devices 22. Software architecture 120 comprises a web browser 122, and a network client 126 configured to manage connections to the wireless network 20. The participant computing device 22 may also comprise an event client 124 stored therein, which is configured to communicate with the event server 26 to enable the participant computing device 22 to join an event session. However, the participant computing device 22 need not comprise the event client stored therein. In this case, the participant computing device 22 downloads the event client 112 from the web server 110 of the event computing device 12 prior to joining the event session.

FIG. 4 shows the software architecture 140 of one of the participant computing devices 30. Software architecture 140 comprises a scheduling client 142 which is configured to communicate with the scheduling server 28 to set up and update event schedules. Software architecture 140 also comprises an event client 144. The event client 144 is configured to communicate with the event server 26 to enable the participant computing device 30 to join an event session. Software architecture 140 further comprises a network client 146 configured to manage wired or wireless connections to the network 24.

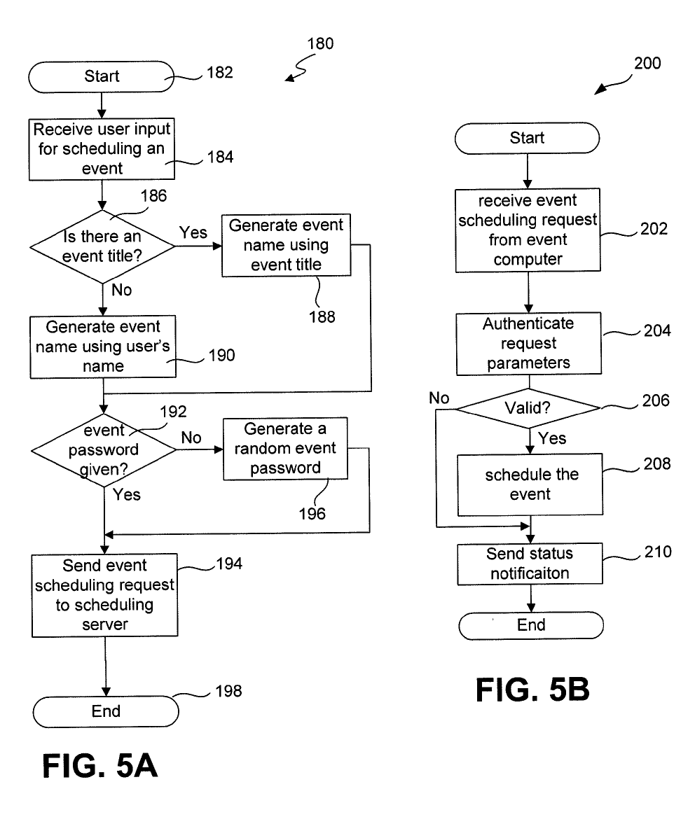

FIG. 5A is a flowchart showing steps of an event scheduling request process used by the collaboration system 10, and which is generally indicated by reference numeral 180. Process 180 starts when a user of the event computing device 12 or one of the participant computing devices 30 invokes an event scheduling command via a user interface (UI) of the scheduling client 102 or 142, respectively (step 182). The event scheduling command comprises input data for scheduling an event that has been entered by the user. After the scheduling client 102 or 142 receives the entered input data (step 184), the scheduling client determines whether an event title is provided in the entered input data (step 186). If an event title is provided, the scheduling client 102 or 142 generates an event name based on the event title (step 188), and the process proceeds to step 192. If at step 186 it is determined that no event title is provided, the scheduling client 102 or 142 then generates an event name according to defined rules (step 190). In this embodiment, the defined rules direct the scheduling client 102 or 142 to generate an event name using the name of the user scheduling the event. At step 192, the scheduling client 102 or 142 determines whether an event password is provided in the entered input data. If an event password is provided, the process proceeds to step 194; otherwise, the scheduling client 102 or 142 generates a random event password (step 196), and the process proceeds to step 194. At step 194, scheduling client 102 or 142 sends the event scheduling request together with the event name and the event password to the scheduling server 28 (step 194), and the event scheduling request process ends (step 198).

FIG. 5B is a flowchart showing steps of an event scheduling process used by the collaboration system 10, and which is generally indicated by reference numeral 200. Process 200 is carried out on the scheduling server 28. Upon receiving an event scheduling request from the scheduling client 102 or 142 of event computing device 12 or one of the participant computing devices 30 (step 202), the scheduling server 28 authenticates the request (step 204) by verifying that request parameters, such as the event name and the event password, have been provided. The scheduling server 28 then determines if the request parameters are valid (step 206). Upon determining that the request parameters are valid, the scheduling server 28 schedules the event (step 208) and sends an event notification to participants (step 210). In this embodiment, the event notification is in the form of an invitation email, which comprises the event name and the event password, as well as a wireless network name and a network key, as will be further described below. It will be understood that the event notification need not comprise the wireless network name or the network key. The wireless network name and the network key may alternatively be communicated to participants in other ways.

If at step 206 the request parameters are determined to be invalid, then the scheduling server 28 proceeds to step 210 and sends an alert notification to the scheduling client 102 or 142 of the event computing device 12 or participant computing device 30, alerting the user of the event computing device 12 or participant computing device 30 to the error.

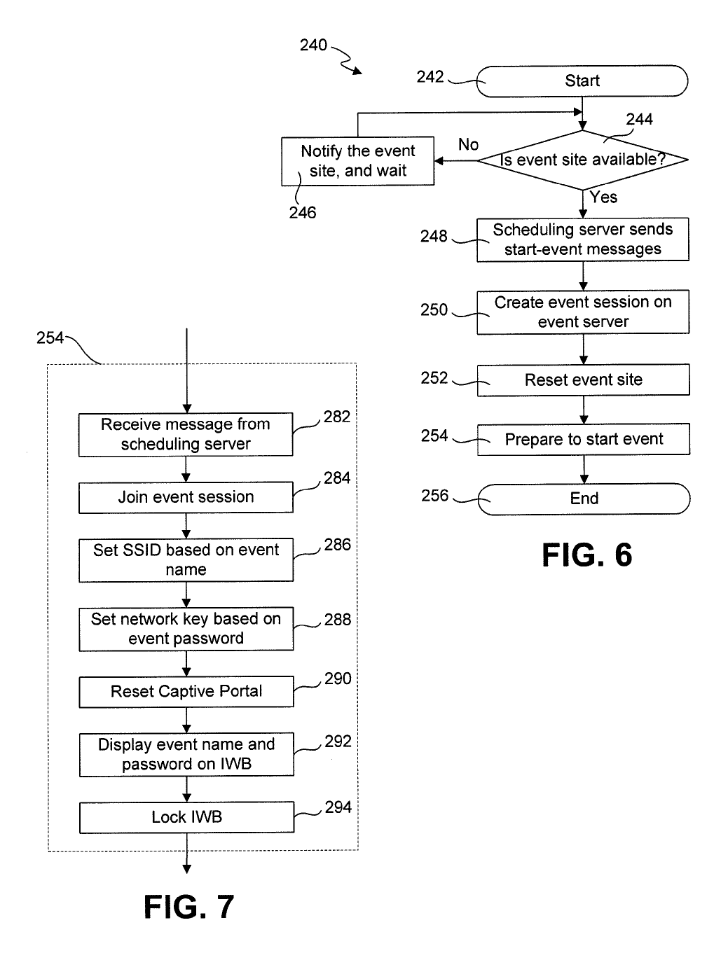

The scheduling server 28 coordinates with the event server 26 to start an event session at the scheduled date and time of the event. FIG. 6 is a flowchart showing steps of an event start process used by the collaboration system 10, and which is generally indicated by reference numeral 240. Process 240 is carried out on the scheduling server 28, on the event server 26 and on the event computing device 12 associated with the event. Process 240 starts automatically at a first defined time period prior to the start of the event (step 242). In this embodiment, the first defined time period is five (5) minutes although other suitable time periods may be employed. The scheduling server 28 then checks the current availability of the event site booked for the ent (step 244), such as for example an event or meeting room. If the event site is not currently available, such as for example, if it is currently occupied, then the scheduling server 28 sends a notification to the event site indicating that the event site needs to be vacated for the upcoming event (step 246). It will be understood that various methods may be used to notify the event site, depending on the collaboration system design and configuration. For example, the scheduling server 28 may send a message to the event computing device 12 instructing the event computing device 12 to display a notification message on the IWB 14 at the event site. After notification has been sent to the event site, the scheduling server 28 waits for a second defined time period, and the process returns to step 244 to determine whether the event site is available. In this embodiment, the second defined time period is one (1) minute although other suitable time periods may be employed.

If at step 244 it is determined that the event site is available, the scheduling server 28 sends a “start-event” message, comprising the event name and the event password, to the event server 26 (step 248). The event server 26 in turn creates an event session using the event name and password (step 250). The scheduling server 28 also sends a “reset-site” message to devices at the event site to reset these devices (step 252). These devices may be, for example, the event computing device 12, event room environment controls, audio and/or video devices, and the like. For example, upon receiving the “reset-site” message, the event computing device 12 may close files that are open, terminate any connections to an existing event session on the event server 26, and terminate running programs or threads associated with the existing event session. Once the event site has been reset, the scheduling server 28 sends a “prepare-event” message comprising the event name and the event password to the event computing device 12, and the event computing device 12 then prepares to start the event (step 254). Following step 254, the event start process 240 terminates (step 256).

FIG. 7 better illustrates steps carried out during step 254 of event start process 240. After receiving the “prepare-event” message from the scheduling server 28 (step 282), the event management module 104 of the event computing device 12 connects the event computing device 12 to the event session on the event server 26 (step 284). The event management module 104 then generates a wireless network name based on the event name received from the event server 26, and instructs, via the network module 106, the wireless network device 18 to use the generated wireless network name as the SSID of the wireless network 20 (step 286). In this embodiment, the wireless network name or “Network_ID” comprises an Event_ID portion and a Site_ID portion separated by a delimiter (e.g., “@”), namely, Network_ID=Event_ID@Site_ID, where the Site_ID is the name of the event site and the Event_ID is determined from the event name. In this embodiment, the Event_ID is the event name if the character length of the resulting Network_ID is less than a threshold of thirty-two (32) characters. If the resulting Network_ID has a character length that is greater than the threshold, then the Event_ID is formed from a truncated event name such that the character length of the resulting Network_ID is less than the threshold. For example, if an event named “Product Demo” is scheduled to start in a room identified as “2C-001”, then at step 286, the event management module 104 of the event computing device 12 generates a Network_ID of “Product Demo@2C-001”, which has a length of nineteen (19) characters, and instructs the wireless network device 18 to set the SSID of the wireless network 20 to the generated Network_ID “Product Demo@2C-001”. As another example, if an event named “Conferencing Product Planning” is scheduled to start in a room identified as “2C-002”, then at step 286, the event management module 104 of the event computing device 12 generates a Network_ID of “Conferencing Product Plan@2C-002”, which comprises a truncated event name so as to not exceed a length of thirty-two (32) characters. The event management module 104 subsequently instructs the wireless network device 18 to set the SSID of the wireless network 20 to the generated Network_ID “Conferencing Product Plan@2C-002”.

The event management module 104 of the event computing device 12 then generates a network key based on the event password received from the event server 26, and instructs the wireless network device 18, via the network module 106, to use the generated network key as the network key of the wireless network 20 (step 288). In this embodiment, the network key generated by the event management module 104 is the event password. The event management module 104 then resets the captive portal 114 (step 290), so that the captive portal 114 intercepts all HTTP requests that are received by the network module 106 from the wireless network device 18, and also displays the event name and the event password on the IWB 14 (step 292). The event management module 104 of the event computing device 12 also displays instructions for joining the event session on the IWB 14, together with a “Start Event” button and forces the IWB 14 to ignore all input except for touch input applied to the displayed “Start Event” button (step 294).

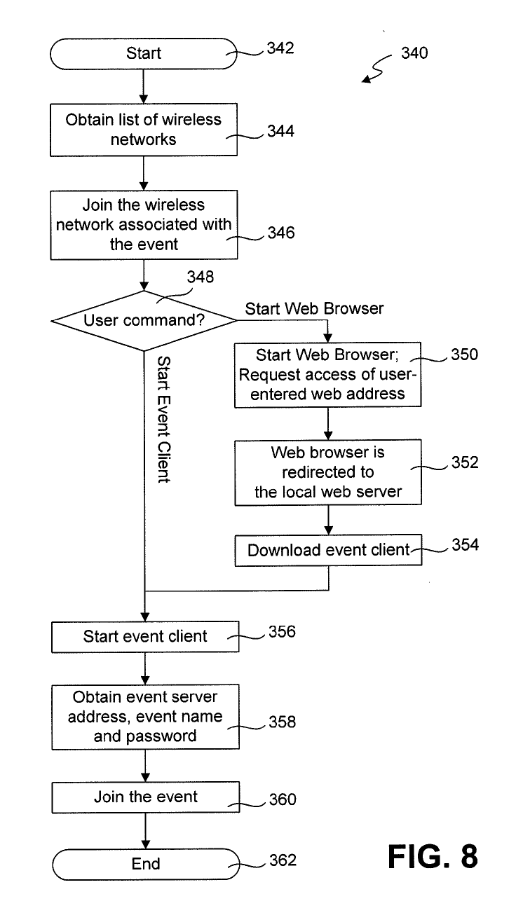

FIG. 8 is a flowchart showing steps of a process used by the collaboration system 10 for joining a participant computing device 22 to an event session on the event server 26 via the wireless network 20, the process being generally indicated by reference numeral 340. As will be understood, during process 340, the participant computing device 22 is assumed to be located within the working range of wireless network 20, so that the participant computing device 22 can establish a wireless communication link with the wireless network device 18. Process 340 starts when the participant computing device 22 is conditioned to search for available wireless networks using a wireless network connection tool thereon (step 342). In this embodiment, the wireless network connection tool is the wireless network connection tool available as part of the Microsoft Windows XP® operating system, which is installed on the participant computing device 22. In response, the wireless network connection tool determines the available wireless networks within range of the participant computing device 22 and presents the available wireless networks in a list (step 344). When the user selects the wireless network 20 from the list that bears the network SSID derived from an event name known to the user and enters the network key, the participant computing device 22 connects to the wireless network 20 (step 346). Having connected to the wireless network 20, the DHCP server 108 assigns an IP address to the participant computing device 22.

The participant computing device 22 then awaits a command from the user (step 348). If the event client 124 is installed on the participant computing device 22, and the user initiates a command to start the event client (step 348), such as for example by double-clicking an icon of the event client on the participant computing device desktop, then the event client 124 is started (step 356). If at step 348 the user initiates a command to start or launch a web browser and the event client 124 is not installed on the participant computing device 22, then the web browser is started and an HTTP request bearing a web address is sent by the participant computing device 22 to the event computing device 12 via the wireless network 20 (step 350). The web address is a default home page, if one has been set, or a web address entered by the user. The captive portal 114 of the event computing device 12 intercepts the HTTP request and redirects it to the web server 110 (step 352). The web server 110 in turn responds to the HTTP request by sending a web page comprising a link for downloading the event client 112 to the participant computing device 22. After the user of the participant computing device 22 selects the link, the event client 112 is downloaded onto the participant computing device 22 (step 354), and is then started (step 356). As will be appreciated, the event client 112 can be downloaded as an installation package, a compressed file, an executable binary file, etc., and the downloaded event client may need to be installed before it can be executed, or it may be executed without installation.

Once the event client 112 or 124 has been started at step 356, the event client on the participant response device 22 determines the address of the event computing device 12, and obtains event information therefrom (step 358). In this embodiment, the event computing device 12 is the default gateway of the wireless network 20. Therefore, the event client 112 or 124 determines the address of the event computing device 12 by requesting the address of the default gateway. The event client then obtains from the event computing device 12 the address of the event server 26, and the event name and the event password of the event session to which the event computing device 12 is currently joined. The event client 112 or 124 then uses the obtained information to join the event session (step 360), and the process ends (step 362). Approaches for connecting participant computing device 30 to an event session via the network 24 are known in the art, and will not be described herein.

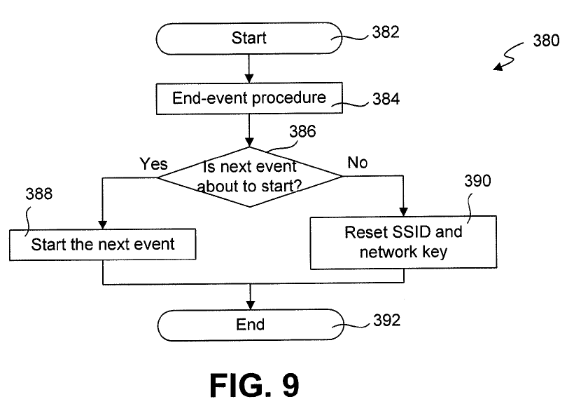

FIG. 9 is a flowchart 380 showing steps of an event end process used by the collaboration system 10, and which is generally referred to by reference numeral 380. Process 380 starts when the event server 26 receives an “end-event” message (step 382). The “end-event” message is triggered by the event computing device 12, and causes an “End Event” button displayed on IWB 14 to be enabled. Also, an end-event procedure is invoked, during which tasks for ending the event are carried out (step 384). In this embodiment, the tasks for ending the event comprise terminating shared audio, video and data streams, terminating the event session, closing files that were opened during the event, generating event minutes, and changing the status of the event site to “available”.

Following step 384, the scheduling server 28 checks to determine if any scheduled event is about to start (step 386). If it is determined that a scheduled event is about to start, then the scheduling server 28 starts the scheduled event session according to the event start process 240 described above (step 388); otherwise, the event computing device 12 resets the SSID and network key of the wireless network 20 (step 390). In this embodiment, the event computing device 12 runs a SMART Meeting Pro™ application, which automatically creates a new event in the event server 26 using a defined event name, such as for example the name of the event site, and a randomly generated password, when an event is terminated and no scheduled event is about to start. Therefore, at step 390, after the new event is created, the event computing device 12 sets the SSID and network key of the wireless network 20 using the defined event name and the randomly generated event password, respectively. The end event process then ends (step 392).

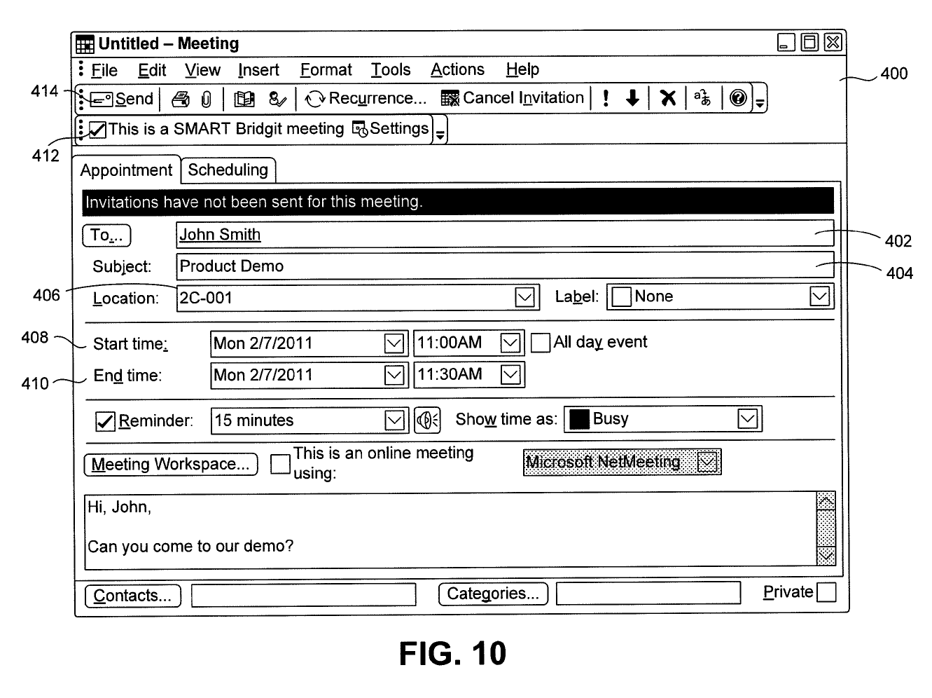

FIGS. 10 to 14 show graphical user interfaces presented during an event in the form of a meeting. As mentioned above, scheduling client 102 or 142 may comprise Microsoft Outlook® having a SMART Bridgit™ plug-in. In this example, when an event scheduling command has been invoked, the scheduling client 102 or 142 presents a graphical user interface comprising a “new meeting” window 400, as shown in FIG. 10. The window 400 comprises an event invitee field 402, in which desired event participants or invitees are entered, an event name field 404 (“Product Demo”, in the example shown), an event site field 406 (2C-001, in the example shown), an event start-time field 408 and an event end-time field 410. The window 400 further comprises a “This is a SMART Bridgit meeting” selection box 412 that may be selected to indicate that an event session is to be scheduled on the event server 26. The window 400 also comprises a “Send” button 414 that may be selected to send an event scheduling request to the event scheduling server 28. Upon receipt of the event scheduling request, the event scheduling server 28 schedules the event at the date and time specified in fields 408 and 410.

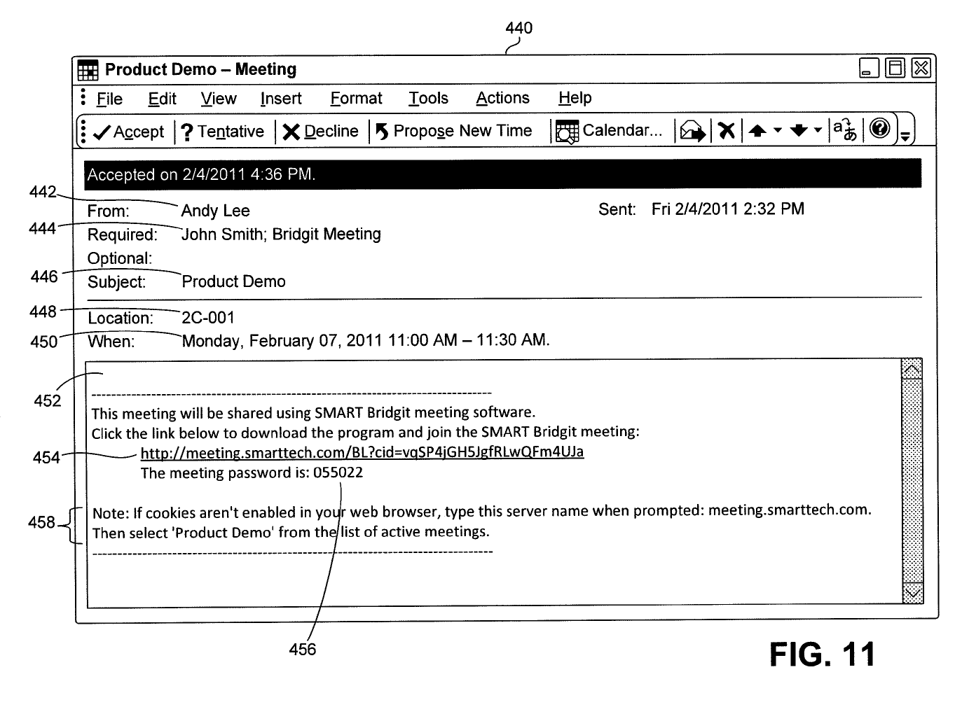

FIG. 11 shows an invitation email message window 440 received by a desired event participant specified in the event invitee field 402. The event invitation email message window 440 comprises an event host name 442, an event invitees list 444, an event name 446, an event site 448, an event start date and time 450, and a description 452 of the event. The description 452 comprises a link 454 for joining the event session, the event password 456, and instructions 458 for joining the event. If the event server 26 is accessible to the participant computing device of the desired event participant, namely if the event invitee is using a participant computing device 30 that is on the same network 24 as the event server 26, then the event invitee may select the link 454 and enter the event password 456 to join the event session, or may follow the instructions 458 to join the event session.

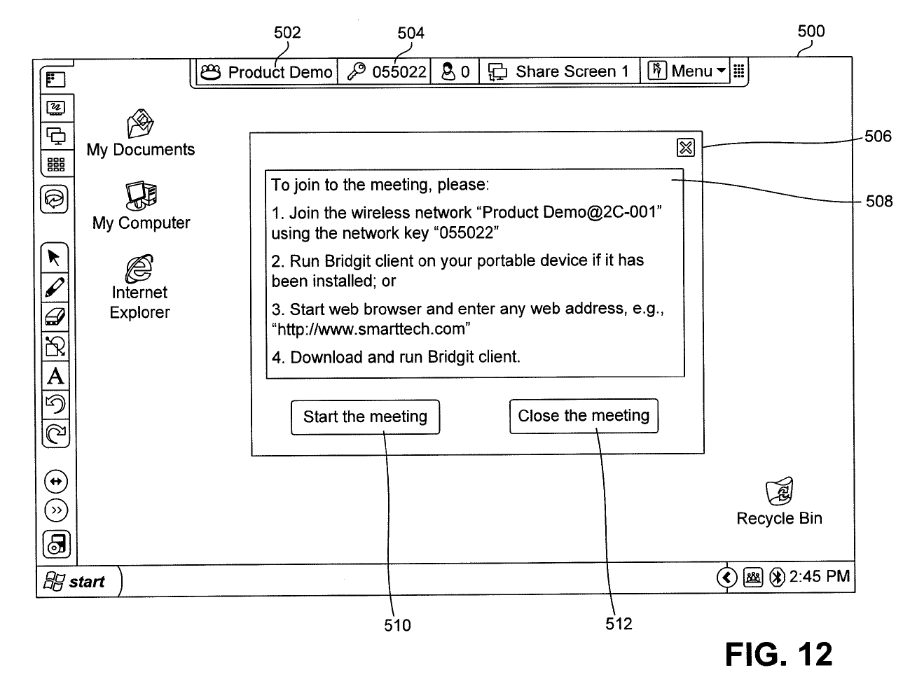

As described above, when the event is about to start, the scheduling server 28 checks the availability of the event site and, if the event site is available, notifies the event server 26 to create an event session with the event name “Product Demo” and a randomly generated event password. The scheduling server 28 then notifies the event computing device 12 at the event site to join the event session. In this example, the event computing device 12 runs a SMART Meeting Pro™ Premium application that presents a graphical user interface comprising a window 500, as shown in FIG. 12. After joining the event session “Product Demo”, the SMART Meeting Pro™ Premium application displays the window 500, comprising the event name 502 and the event password 504 on the IWB 14. The SMART Meeting Pro™ Premium application locks the event computing device 12 and presents a dialogue box 506 in the window 500 comprising instructions 508 for joining the event via the wireless network 20 managed by the wireless network device 18 in the event room. The dialogue box 506 also comprises a “Start the meeting” button 510, which may be selected to unlock the event computing device 12 and to start the event session “Product Demo”, and a “Close the meeting” button 512, which may be selected to unlock the event computing device 12 and end the event session. The SMART Meeting Pro™ Premium application also generates a wireless network name based on the event name (“Product Demo@2C-001” in the example shown), and a network key, which in this example is the same as the event password, and instructs the wireless network device 18 to set the SSID and the network key of the wireless network 20 accordingly.

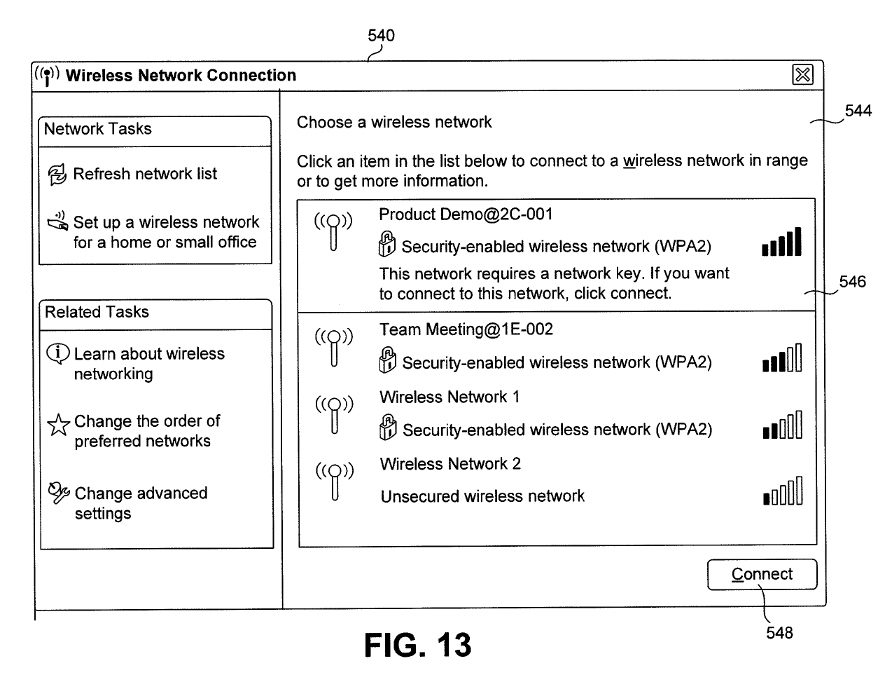

A participant using a participant computing device 22 may then join the event session via the wireless network 20. To do so, the participant may use the wireless network connection tool included in the operating system of the participant computing device 22, which presents a graphical user interface comprising a window 540, as shown in FIG. 13. Window 540 comprises a dynamically updated list 544 of wireless networks. In the example shown, the list 544 comprises a wireless network icon 546 identified as “Product Demo@2C-001”, which is the SSID of the wireless network 20. The window 540 also comprises a “Connect” button 548, which may be selected once one of the wireless networks shown in the list 544 has been selected, in order to connect to the selected wireless network by entering the network key of the selected network.

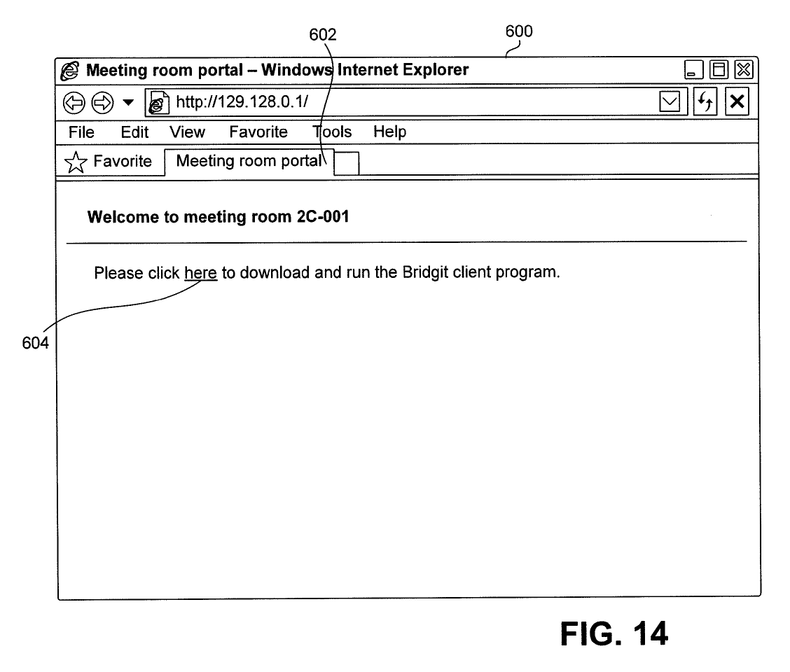

After joining the wireless network 20, the participant may start or launch a web browser, such as for example, Microsoft Internet Explorer®, Firefox®, Safari®, etc., which presents a graphical user interface comprising a window 600 as shown in FIG. 14. In the example shown, the web browser is Microsoft Internet Explorer®. Once the web browser has been started, the participant may enter an arbitrary web address into the address bar thereof, resulting in an HTTP request corresponding to the entered web address being redirected by the captive portal 114 of the event computing device 12 to the local web server 110 as described previously. A web page 602 generated from the web server 110 is then displayed in the window 600. The web page 602 comprises a link 604 to the event client 112, such as the SMART Bridgit™ client program. The participant may then select the link 604 to download and install the event client 112 on the participant computing device 22. Once installed, the event client 112 is executed to obtain the address of the default gateway, which in this embodiment, corresponds to the event computing device 12. The event client 112 also obtains the address of the event server 26, and the event name and the event password therefrom and uses the obtained information to join the participant computing device 22 to the event session.

The downloaded event client 112 may be stored by the participant computing device 22 so that when the participant wishes to join an event session in the future, once the participant computing device 22 has connected to the wireless network 20 associated with the event, the event client 112 can be launched to join the participant computing device 22 to the event session, as described above.

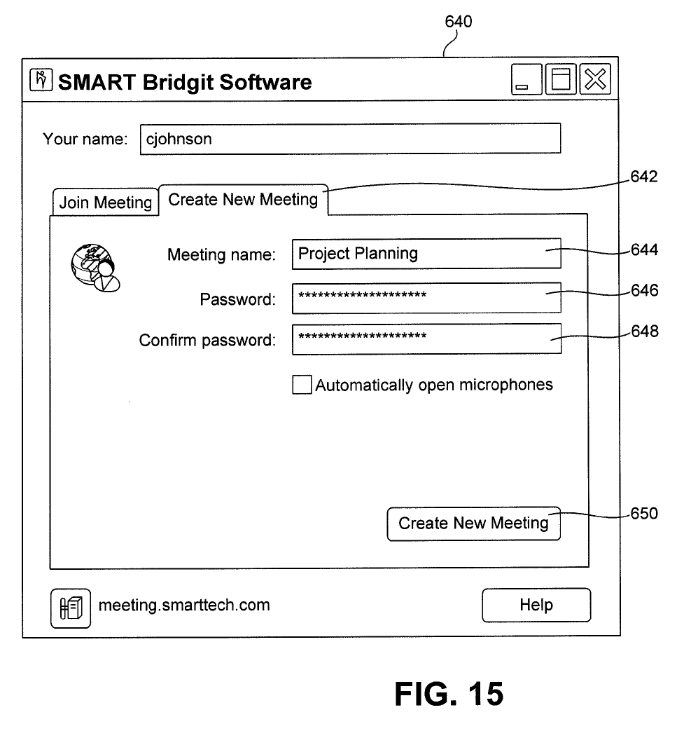

The collaboration system may also allow users to start and join ad-hoc event sessions. For example, in one such embodiment, a SMART Bridgit™ client program is installed on the event computing device 12 and is used as the event management module 104. Upon starting the SMART Bridgit™ client program, a graphical user interface comprising a window 640 is presented, as shown in FIG. 15. The window 640 comprises a “Create New meeting” tab 642, which may be selected by a user for creating a new event. The window 640 also comprises an event name field 644 (“Project Planning”, in the example shown), an event password field 646 and an event password confirmation field 648. The window 640 also comprises a “Create New Meeting” button 650, which may be selected by a user once information has been entered in fields 644 to 648, to create an event session on the event server 26 having the name entered in field 644. After the event session has been created, the event computing device 12 generates a wireless network name and password based on the event name and the event password, and instructs the wireless network device 18 to set the SSID and network key of the wireless network 20 accordingly. Participant computing devices 22 may then join the event session, as described above.

In this embodiment, after the event ends, the corresponding event session in the event server 26 is terminated. The SMART Bridgit™ client program then instructs the wireless network device 18 to terminate the wireless network 20, such as for example, by instructing the wireless network device 18 to stop communication with participant computing devices 22 connected thereto. The SMART Bridgit™ client program is then terminated in the event computing device 12.

As mentioned previously, the event client 124 may be pre-installed on one or more of the participant computing devices 22. In this case, each pre-installed event client 124 stores a user customizable default event server address. In this embodiment, when used to join an event, the pre-installed event client 124 first searches for the event in its default event server 26, and if the event is not found, the event client then searches for a wireless network 20 associated with the event.

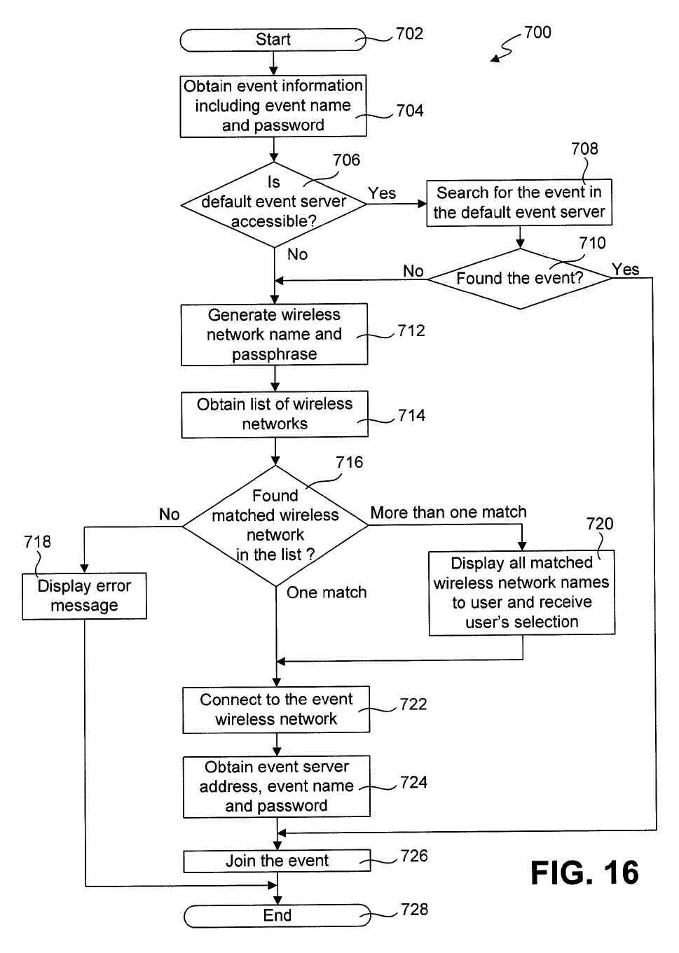

FIG. 16 is a flowchart showing steps performed by pre-installed event client 124 to join an event session, the process being generally indicated by reference numeral 700. Process 700 starts when the user invokes a command to execute the pre-installed event client 124 (step 702). In response, the event client 124 prompts the user to enter the event name and password (step 704). In this step, the event client 124 also prompts the user to enter an event site name. After receiving the event name, the event password and the event site name, the event client 124 then checks whether the default event server 26 is accessible by sending the default event server 26 a query message, such as for example, a “ping” message (step 706). If the default event server 26 is accessible, the event client 124 sends a query to the default event server 26 requesting the event name (step 708). If the default event server responds to the query with the event name (step 710), then the event client 124 joins the participant computing device 22 to the event session using the obtained event name and password (step 726). If at step 710 the event name is not found by the default event server 26, the event join process proceeds to step 712.

If at step 706 the default event server 26 is not accessible, then the event client 124 generates a wireless network name and password using the same rules as those followed by the event computing device 12 during steps 286 and 288 of process 240 described above (step 712). In this embodiment, the wireless network ID is the event name concatenated with a Site_ID, namely the event site name, using the delimiter character (e.g. “@”). If a Site_ID is obtained at step 704, then the event client 124 generates a wireless network name by concatenating the event name to the delimiter character (e.g., “@”) and the Site_ID. If, however, no Site_ID is obtained at step 704, then the event client 124 uses the event name as the wireless network name.

At step 714, the event client 124 instructs the network client 126 running on the participant computing device 22 to obtain a list of available wireless networks. The event client 124 then determines if any of the wireless networks in the list match the generated wireless network name (step 716), namely if the name of any of the wireless networks in the list is the same as, or begins with, the generated wireless network name. If no wireless network in the list matches the generated wireless network name, then the event client 124 displays an error message (step 718), and the event join process ends (step 728). If at step 716, only one wireless network in the list matches the generated wireless network name, then the event client 124 determines that the matched wireless network is the wireless network associated with the event, and connects to the matched wireless network using the network key generated at step 712 (step 722).

If at step 716 more than one wireless network in the list matches the generated wireless network name, then the event client 124 displays all matching wireless networks to the user and waits to receive a selection by the user of a wireless network to join (step 720). The event client 124 then connects to the wireless network selected by the user using the password generated at step 712 (step 722). After connecting to the wireless network, the event client 124 obtains the address of the event server 26, and the event name and password (step 724), and joins the event session (step 726), after which the event join process terminates (step 728).

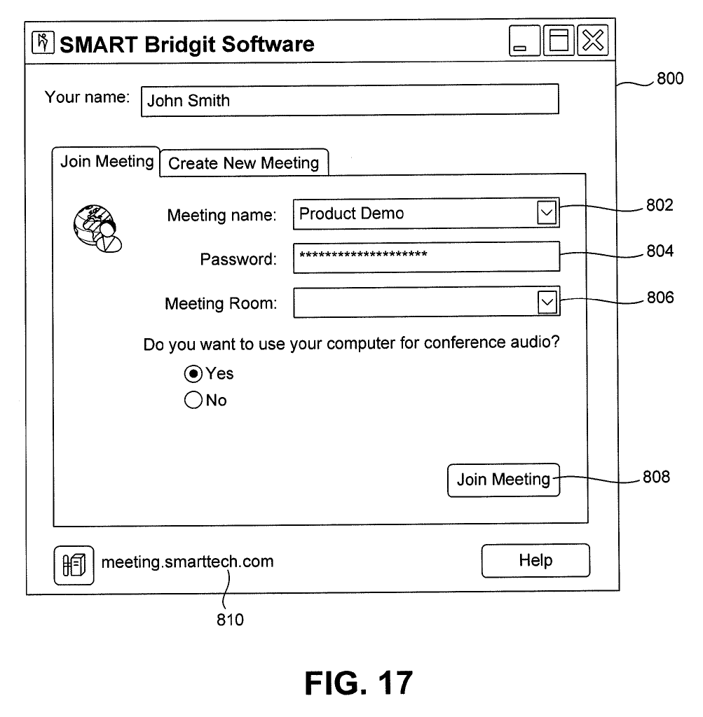

FIG. 17 shows a window of a graphical user interface presented by an event client 124 running on a participant computing device 22 during the process 700, the window being generally referred to by reference numeral 800. Window 800 is displayed when the event client 124 is executed. In the embodiment shown, the event is a meeting. Window 800 comprises an event name field 802 (“Product Demo”, in the example shown) and an event password field 804. The window 800 also comprises an event site field 806, and an address field 810 in which the default event server address is displayed.

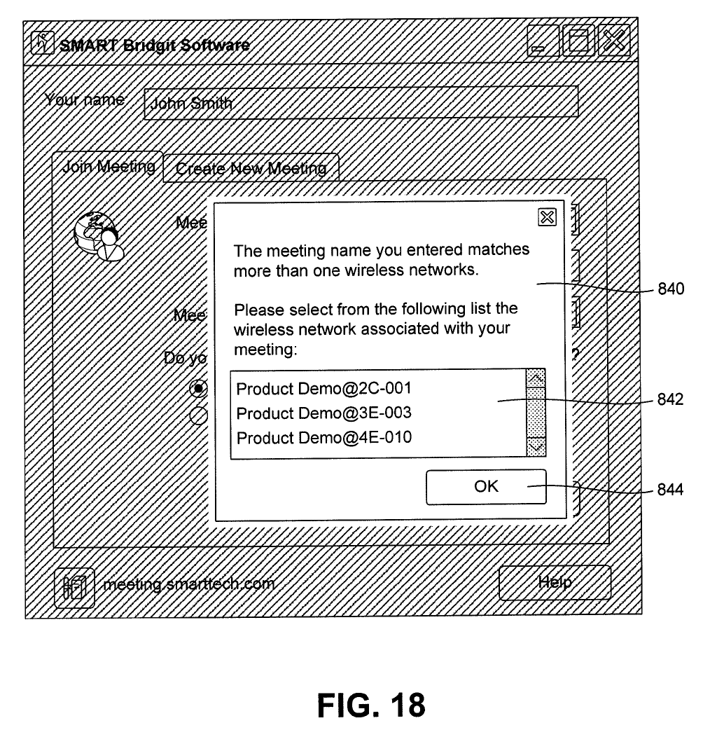

Window 800 further comprises a “Join Meeting” button 808. Upon selection of the button 808 by a user, the event client 124 determines whether the default event server address shown in field 810 is accessible. In the example shown, the participant computing device 22 is not yet connected to a wireless network, and thus the default event server address is not accessible. Accordingly, the event client 124 generates a wireless network name based on the information entered in fields 802 and 806. In the example shown, an event site name has not been entered in the event site field 806. The event client 124 therefore generates a wireless network name of “Product Demo”. The event client 124 then instructs the network client 126 running on the participant computing device 22 to obtain a list of available wireless networks starting with the generated wireless network name. Once the list is obtained, the event client 124 displays the obtained list of available wireless networks in a dialogue box 840, as shown FIG. 18. The dialogue box 840 comprises a list 842 of the available wireless networks matching the generated partial wireless network name. The window 840 further comprises a confirmation button 844, which may be selected after one of the wireless networks shown in the list 842 has been selected. Once button 844 has been selected, the event client 124 uses the generated password to connect to the selected wireless network, and then joins the specified event session.

In another related embodiment, the event information may be sent to desired event participants in an invitation email, as described above. In such an embodiment, the event client obtains the event name, event password and event site name from the invitation email.

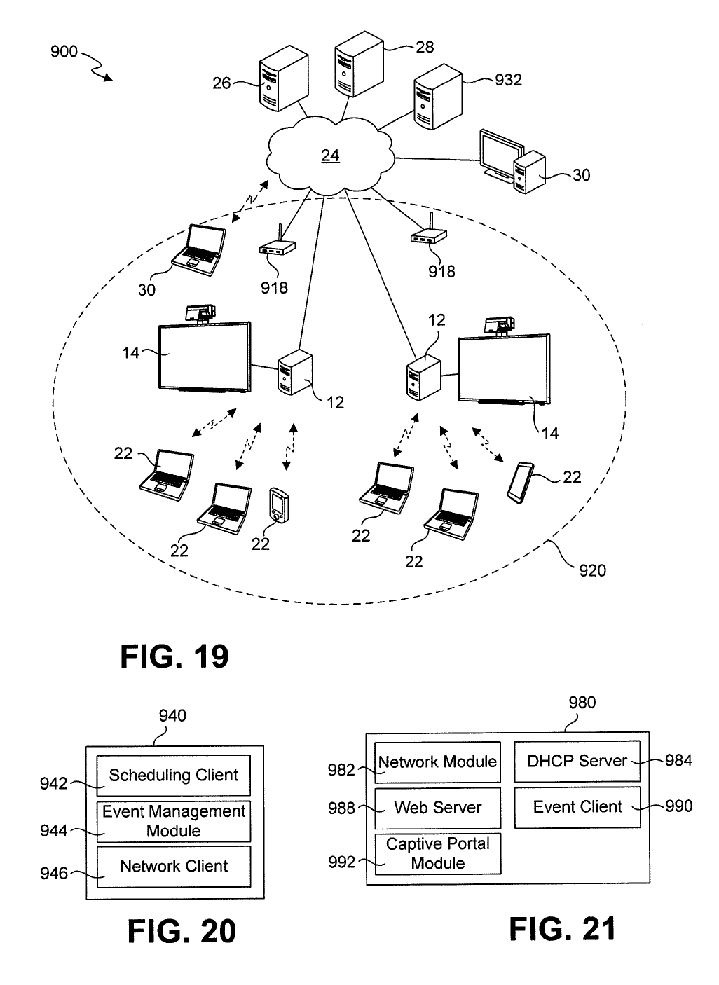

Still other collaboration system configurations are possible. For example, FIG. 19 shows another embodiment of a collaboration system, which is generally indicated by reference numeral 900. As can be seen, in this embodiment collaboration system 900 comprises a plurality of event computing devices 12, each of which is physically located at an event site, such as for example an event or meeting room, and which is connected to an associated IWB 14. Each event computing device 12 is in communication with a network 24 over a wired or a wireless connection. Servers including an event server 26 and a scheduling server 28 and one or more participant computing devices 30 are also in communication with the network 24 over wired or wireless connections.

Collaboration system 900 also comprises a network management server 932 and a plurality wireless devices 918, such as for example wireless access points, connected to the network 24. The network management server 932 is configured to control the wireless devices 918 to manage a wireless network 920 covering the organization, including event sites having an event computing device 12 located therein. Each of the wireless network devices 918 may provide a wireless network service to one or more event sites, and more than one wireless device 918 may provide a wireless network service to the same event site.

The network management server 932 is configured to control the wireless devices 918 to create a virtual wireless network for each event. The virtual wireless network is at least a subset of the wireless network 920, but has a respective wireless network name, a respective network key, and respective access rights settings. In this embodiment, all virtual wireless networks have the same working range as, and thereby provide wireless network access to the same area as, the wireless network 920. However, in some embodiments, the network management server 932 may control the wireless devices 918 so that each virtual wireless network has its own wireless network coverage. As is further described below, when an event starts, the network management server 932 controls the wireless devices 918 to create a virtual wireless network for each event having a wireless network name and network key generated from the event name and the event password. An event participant may then select the virtual wireless network, and join the event session via the wireless network 920 using the participant computing device 22.

FIG. 20 shows the software architecture of one of the event computing devices 12 forming part of collaboration system 900, and which is generally identified by reference numeral 940. Software architecture 940 comprises a scheduling client 942, which is configured to communicate with the scheduling server 28 to set up and update event schedules, an event management module 944, which is configured to communicate with the event server 26 to join an event session, and a network client 946, which is configured to manage a wired or wireless connection to the network 24.

FIG. 21 shows the software architecture of the network management server 932, and which is generally identified by reference numeral 980. The software architecture 980 of the network management server 932 comprises a network module 982, a DHCP server 984, a web server 988, an event client 990, and a captive portal module 992. The network module 982 is configured to control the wireless network 920, and to create and manage one or more virtual networks using the wireless network 920. Each virtual network is assigned a network ID, such as for example a network SSID, and is associated with an event, so that a participant may join an event by identifying the virtual network associated with the event. When a participant computing device 22 is connected to the wireless network 920, the DHCP server 984 assigns an IP address thereto. The web server 988 comprises a web portal interface with a download link to the event client 990 stored in the network management server 932. The captive portal 998 is configured to monitor network-related requests sent from the participant computing device 22, and to redirect at least some requests to the web server 988. Therefore, a participant computing device 22 connecting to the wireless network 920 may initiate a request to any web site, and the request is automatically redirected to the web portal interface to allow the user to download desired information such as the event client.

The collaboration system 900 uses an event scheduling request process and an event scheduling process that are similar to the event scheduling request and the event scheduling processes 180 and 200 described above with reference to FIGS. 5A and 5B, respectively. The collaboration system 900 also uses an event start process that is generally similar to the event start process 240 described above with reference to FIG. 6. However, and referring to FIG. 6, when an event is about to start and the event site is available (step 244), the scheduling server 28 forming part of collaboration system 900 sends “start-event” messages to the event server 26, the relevant event computing device 12 and the network management server 932 (step 248). The event start process used by the collaboration system 900 uses steps 246, 250 and 252 of the event start process 240 shown in FIG. 6.

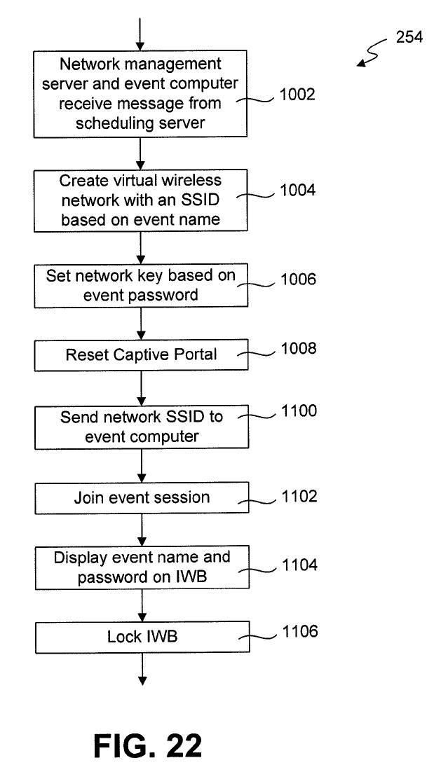

FIG. 22 shows steps carried out by the collaboration system 900 during step 254 of the event start process. After receiving “start-event” messages from the scheduling server 28, both the network management server 932 and the relevant event computing device 12 prepare to start the event. At step 1002, the network management server 932 and the event computing device 12 receive “start-event” messages from the scheduling server 28. The network management server 932 then creates a virtual wireless network having an SSID based on the event name (step 1004), and sets a network key based on the event password (step 1006). The network SSID and the network key are generated as described above. The network management server 932 then resets the captive portal 992 (step 1008), and sends the network SSID to the event computing device 12 (step 1100). The event computing device 12 then joins the event session (step 1102), and displays the event name and password on the IWB 14 (step 1104). The event computing device 12 may also display instructions for joining the event session using a virtual wireless network, as described above. The event computing device 12 then locks the IWB 14 and waits for the event session to start (step 1106).

The collaboration system 900 uses a process for joining a participant computing device 22 to an event session that is generally similar to process 340 described above with reference to FIG. 8, with the exception that, at step 358, the event client 990 obtains the address of the event server 26, the event name and the event password from the network management server 932. Given that the virtual wireless network is associated with the event, the network management server 932 detects the virtual wireless network that the participant computing device 22 is connected to, and determines the event server address, the event name and the event password, which are then sent to the participant computing device 22.

The collaboration system 900 also uses a process for ending an event that is generally similar to the event end process 340 described above with reference to FIG. 9. During the event end process used by the collaboration system 900, the network management server 932 deletes the virtual wireless network associated with the event.

In embodiments described above, once a participant computing device 22 has connected to the wireless network 20 or a virtual network of the wireless network 920, the captive portal 114 or 992 redirects all HTTP requests to the web server 110 or 988, respectively. After the participant computing device 22 has joined the event, the captive portal 114 or 992 stops redirecting HTTP requests, so that participant computing device 22 may access the Internet or other network resources. In some embodiments, once a participant computing device 22 has connected to the wireless network and has initiated an HTTP request, the captive portal does not redirect the HTTP request to the web server. Rather, the HTTP request is instead sent to the Internet to obtain the requested web pages. The requested web pages from the Internet may be displayed in a page frame which includes a download link to the event client 112, or 990.

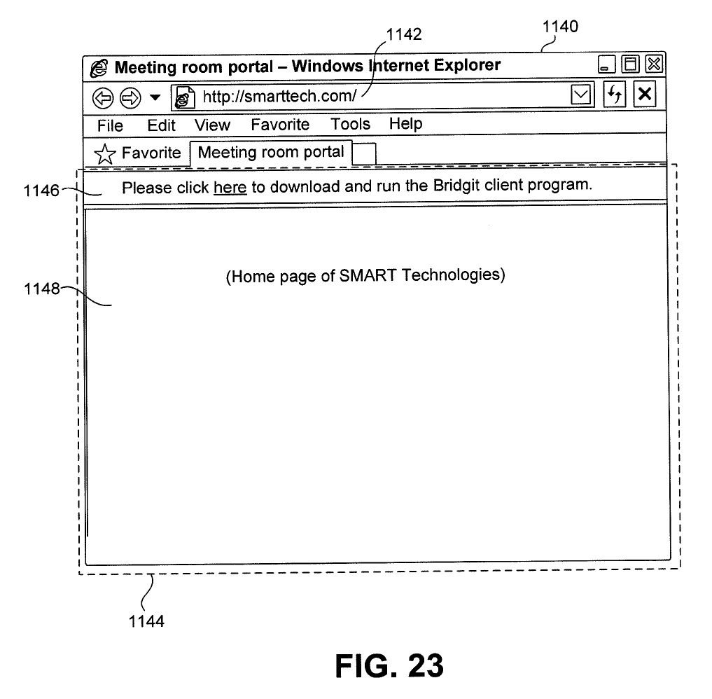

For example, FIG. 23 shows a window of a graphic user interface presented by a web browser running on a participant computing device 22 after the participant computing device has joined the event, and which is generally indicated by reference numeral 1140. The window 1140 comprises an address field 1142 in which a participant enters a web address (“http://smarttech.com”, in the example shown). A first portion 1146 of page frame 1144 shows the download link to the event client 112 or 990. The requested web page is returned and is displayed in a second portion 1148 of the page frame 1144. Those skilled in the art will appreciate that other information may also be shown in the first portion 1146 of the page frame 1144.

Those skilled in the art will appreciate that, in some embodiments, the captive portal 114 or 992 may redirect all HTTP requests it receives from participant computing devices 22 to the web server 110 or 988.

In other alternative embodiments, after the participant computing device connects to a wireless network and enters a web address in the web browser, the captive portal 114 or 992 instructs the web server 110 to return the event client to the web browser, so as to trigger the web browser to display a dialogue box prompting the participant to download the event client. The participant then may choose to download and run the event client.

Those skilled in the art will appreciate that in some embodiments the collaboration system may not include a captive portal, in which case participants are required to enter the address of the web server in the web browser in order to download the event client.

Those skilled in the art will also appreciate that in some alternative embodiments, the event computing device 12 of collaboration system 10 or the network management server 932 of collaboration system 900 assigns IP addresses to pre-registered computing devices, so that these computing devices always have the same IP addresses when they join an event. In some related embodiments, the event computing device 12 may alternatively not comprise a DHCP module, and thus any computing device connecting to the wireless network 20 or 920 requires a predetermined IP address. In another embodiment, the event computing device 12 or network management server 932 comprises a whitelist of computing devices, such as for example a list of media access control (MAC) addresses of computing devices, and thus only the computing devices pre-registered in the whitelist can connect to the wireless network 20 or 920. Similarly, in some alternative embodiments of collaboration system 900, some wireless devices 918 may be reserved such that only some pre-registered computing devices can join the wireless network 920 or a virtual network thereof via the reserved wireless devices 918. Therefore, an event session, together with the virtual wireless network associated therewith, communicated by these reserved wireless devices 918 can only be accessed by pre-registered computing devices.

In other embodiments, the collaboration system may further comprise a DNS server, which translates a domain name to a corresponding IP address.

Those skilled in the art will appreciate that various methods may be used to generate the name and password for the wireless network 20, or for a virtual network based on the wireless network 920. For example, in one alternative embodiment, the wireless network name and password, respectively, may be identical to the event name and password. In another embodiment, the event server 26 of collaboration system 10 maintains a list of generated wireless network names for ongoing events. When an event computing device 12 generates a wireless network name, it generates the wireless network name in a manner such that the generated wireless network name is unique among the names of all ongoing events. For example, the event computing device 12 may first query the event server 26 to determine whether the event name has been used to generate a wireless network name for an ongoing event. If so, the event computing device 12 generates a wireless network name from the event name based on a predefined rule, as described above; otherwise, the event computing device 12 generates a wireless network name that is the same as the event name. In yet another embodiment, the event server 26 of the collaboration system 900 maintains a list of generated wireless network names for ongoing events, and the network management server 932 queries the event server 26 and generates a virtual wireless network name that is either the same as the event name or derived from the event name based on a predefined rule to ensure that the generated event name is unique among the names of all ongoing events. In still another embodiment, each wireless network name may be a unique, randomly generated name.

Although in the embodiment shown in FIG. 19, a wireless network device 918 may provide wireless network service to multiple event sites, in other embodiments, each event site may alternatively be equipped with at least one wireless network device 918. In a related embodiment, a wireless network device 918 may alternatively be configured such that it only covers a limited area including the event site at which it is installed. The virtual wireless network for an event is created on the wireless network device 918 that is in or near to the event site hosting the event such that it is only detectable and accessible within a limited area including the event site. Therefore, a participant computing device 22 may only discover a limited number of virtual wireless networks. Alternatively, the network management server 932 maintains information pertaining to the coverage of each wireless network device 918. Accordingly, when generating a virtual wireless network name, the network management server 932 only checks the names of the virtual wireless networks detectable around the scheduled event site, and ensures that the generated virtual wireless network name is unique with respect to the names of those “neighbouring” virtual wireless networks. Therefore, the name of a virtual wireless network may be reused by a virtual wireless network at a remote event site.

Although in above embodiments the collaboration system 900 comprises multiple server computing devices, namely servers 26, 28 and 932, in some alternative embodiments, the servers 26, 28 and 932 may be implemented in a single computing device. In a related embodiment, the servers 26, 28 and 932 may be implemented on the event computing device 12.

Although the collaboration system 10 shown in FIG. 1 comprises a network 24, servers 26 and 28 and one or more participant computing devices 30, in an alternative embodiment, the collaboration system 10 only comprises an event computing device 12 connected to an IWB 14 and a wireless network device 18 that allows one or more participant computing devices 22 to join the wireless network 20. Such a collaboration system may be used for ad-hoc events that are not required to be scheduled by a scheduling server.

In some alternative embodiments, at least some event computing devices 12 are not connected to IWBs. Rather, they may be connected to other types of displays such as for example cathode ray tube (CRT) monitors, liquid crystal display (LCD) screens or projectors.

Although in embodiments described above, network wireless devices 18 and 918 are shown as standalone devices, in some alternative embodiments, the network wireless devices 18 and 918 may be integrated into relevant computing devices or networking devices. For example, in an alternative embodiment, the wireless network device 18 may be integrated into the event computing device 12.

Although in above embodiments, network wireless devices 18 and 918 are described as Wi-Fi™ devices, in some alternative embodiments, other wireless devices are used. For example, the wireless devices 18 and 918 may be Bluetooth™ devices each having a device ID that may be modified by the collaboration system 10 or 900 to match an event name.

In yet another embodiment, an event computing device such as event computing device 12 in a first event or session may join a second event or session so that the first event is merged with the second event. In this case, the wireless network name associated with the first event is modified to match the name of the second event, e.g., using the wireless network name of the second event, or a different wireless network name is generated from the name of the second event. All participants in the first event are also automatically moved into the second event. In a related embodiment, when a first event is merged with a second event, the event computing device of the first event checks whether a wireless network having a name corresponding with the second event has already been set up. If not, the event computing device of the first event creates a virtual network having a name corresponding with the second event. Therefore, computing devices connecting to either the wireless network of the first event or that of the second event will join to the same event. In a further related embodiment, an event may correspond to multiple (virtual) wireless networks having different names, each of which is generated according to predefined or user-defined rules.

Although in above embodiments, the wireless network 20 or 920 is encrypted, in some alternative embodiments, the wireless network 20 or 920 is not encrypted. Accordingly, in this case an event participant is able to join the wireless network 20 or 920 without providing a network key. However, the captive portal 114 or 992 blocks all network traffic from the participant computing device 22 until the participant launches a web browser and enters a web address, which is then redirected by the captive portal to a login page. After the participant enters the event password, the captive portal 114 or 992 redirects the web browser to a download page for downloading the event client 112 or 990, and the captive portal 114 or 992 terminates the blocking of the network traffic from the participant computing device 22.

In other embodiments, the event computing device 12 or the network management server 932 may alternatively not comprise any web server, and may instead comprise an FTP server. In one such embodiment, after a participant connects to a wireless network and enters a web address in the web browser, the captive portal 114 or 992 instructs the FTP server to return the event client 112 or 990, respectively, to the web browser, so as to trigger the web browser to display a dialogue box prompting the participant to download the event client.

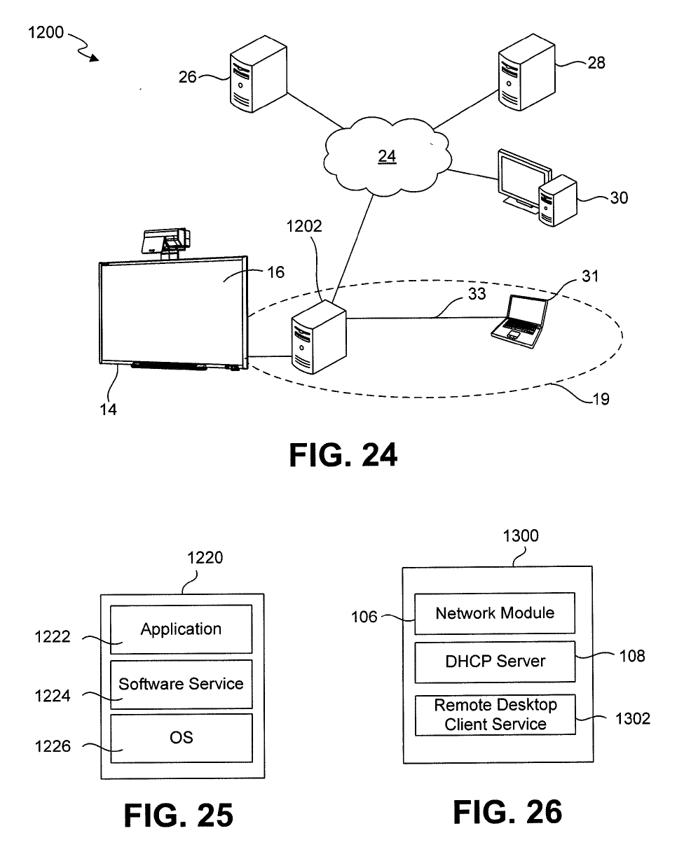

FIG. 24 shows another embodiment of a collaboration system, which is generally indicated by reference numeral 1200. Similar to collaboration system 10 described above with reference to FIG. 1, collaboration 1200 comprises at least one event computing device 1202 that is physically located at the event site, such as for example a meeting room, and that is connected to an IWB 14. The event computing device 1202 is in communication with a network 24 over either a wired or a wireless connection. One or more computing devices including event server 26, scheduling server 28 and one or more computing devices 30 are also connected to network 24, similar to collaboration system 10 described above.

A participant computing device 31, for example, a guest computer used by a guest, is connected to the event computing device 1202. The participant computing device 31 may be any general purpose computing device, such as for example a laptop computer, that is equipped with a network interface in the form of, for example, an Ethernet port. Those skilled in the art will understand that other interfaces and/or ports may also be used.

FIG. 25 shows the software architecture of the participant computing device 31, and which is generally indicated by reference numeral 1220. The software architecture 1220 comprises an operating system 1226, a software service 1224, one or more applications 1222, and other components (not shown), such as for example, device driver, other services, processes and related threads, including other applications, and the like. The software service 1224 may be, for example, a remote desktop service or a terminal service.

FIG. 26 shows the software architecture of the event computing device 1202, and which is generally indicated by reference numeral 1300. The software architecture 1300 comprises a network module 106, a DHCP server 108 and a remote desktop client service 1302.

In operation, when the participant computing device 31 connects to the event computing device 1202 using an Ethernet cable 33 or other suitable connection, the event computing device 1202 creates a private network 19 between participant computing device 31 and the event computing device 1202. After the event computing device 1202 detects the participant computing device 31 connected thereto, the event computing device 1202 assigns an IP address to the participant computing device 31 using its DHCP server 108.

After assigning the IP address to the participant computing device 31, the event computing device 1202 sends a request to the participant computing device 31 requesting a connection thereto using the Remote Desktop Protocol (RDP). A dialogue box requesting a username and a password is then displayed on the IWB 14. After a user of the IWB 14 enters a correct username and password, such as for example the username and password of a user account that has access to the participant computing device 31, the event computing device 1202 takes control of the participant computing device 31; namely the screen image of the participant computing device 31 is transmitted from the participant computing device 31 to the IWB 14, and input to the event computing device 1202 is redirected to the participant computing device 31.

As will be appreciated, the Remote Desktop Protocol (RDP) provides remote display and input capabilities over a network. A local machine executing an RDP client, such as for example the event computing device 1202, sends input data to, and receives display data from a remote device, such as for example the participant computing device 31, over a network, such as for example the network 19. Various types of network protocols are supported. RDP allows for separate virtual channels to carry different types of data, such as graphical presentation data, mouse input data, and keyboard input data. An RDP server on the remote device uses its own video driver to render display output by packing the rendering information into network packets using the RDP protocol and then sending them over the network to an RDP client on the local machine, such as for example the event computing device 1202. The RDP client receives rendering data and interprets the received network packets into corresponding local graphics application programming interface (API) calls to present images on its local display, such as for example IWB 14, for viewing. Input data is processed to redirect mouse and keyboard events to the RDP server. The RDP server uses its own virtual keyboard and mouse driver to receive keyboard and mouse events sent from an RDP client.

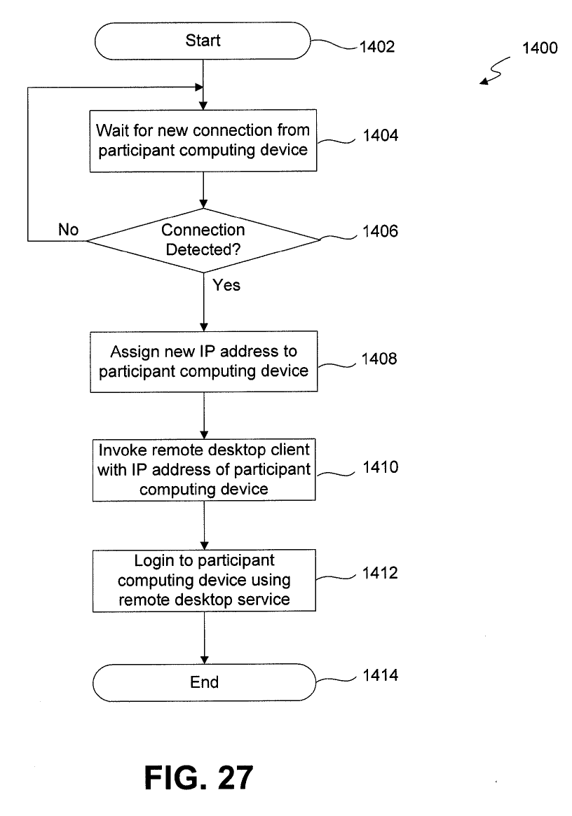

FIG. 27 shows steps of a process carried out by the event computing device 1202 for establishing a private network 19 with the participant computing device 31 and for allowing the participant to share the screen of the participant computing device 31 to the IWB 14, the process being generally indicated by reference numeral 1400.

Process 1400 starts when event computing device 1202 is powered on and executes its software (step 1402), which includes the components of the software architecture 1300. The event computing device 1202 then awaits establishment of a new connection (step 1404), such as for example by way of the Ethernet cable 33 connecting the participant computing device 31 to the event computing device 1202.

If the event computing device 1202 detects a new connection (step 1406), then it assigns a new IP address to the participant computing device 31 using its DHCP server 108 (step 1408). If at step 1406 no new connection is detected, then the process returns step 1404 to await a new connection. After the new IP address has been assigned, the event computing device 1202 then invokes the remote desktop client service 1302 using the newly assigned IP address as a parameter (step 1410), and logs in to the participant computing device 31 using the remote desktop service (step 1412). At this step, the user of the event computing device 1202 is prompted to provide a username and a password of a user account having access to the participant computing device 31. A remote desktop connection is established once the remote desktop client service 1302 logs in to the participant computing device 31 using the username and password provided by the user. The process then ends (step 1414).

At this point, if the software service 1224 of the participant computing device 31 is active and responsive to the remote desktop client service 1302, then the IWB 14 takes over the control of the participant computing device 31. The screen image of the participant computing device 31 is then displayed on the IWB 14, and the IWB 14 can then be used by the guest user for interactive presentation of content using the participant computing device 31.

As will be understood, the detection of a new connection (step 1406) may be implemented in several ways, depending on the configuration of the event computing device 1202 and the participant computing device 31. In this embodiment, the event computing device 1202 has installed thereon a Linux® operating system such as an Ubuntu® distribution, version 9.04. The remote desktop client service 1302 is the rdesktop service running on the operating system, and the DHCP server 108 is a dhcp3-server.

Software code, such as the Perl script presented below, is created and stored as a file having a file name myScript.

while ($line = <STDIN>)
{

If ($line =~ m/dhcpd: DHCPACK on ([0-9\.]+)/)
{

$ip = $1;
system “rdesktop “. $ip;

}

}

The Perl script presented above may be executed in event computing device 1202, on the system log output that would be updated when an IP address is newly assigned, as described below.
tail −f|myScript

Those skilled in the art will understand that other forms of software code, such as for example shell scripts, batch files, executables, operating systems, such as for example Linux®, Windows®, Mac OS®, Unix®, and the like, may alternatively be used.

The DHCP server 108 in the event computing device 1202 running the Ubuntu® operating system may be set up by modifying respective files as shown in Table 1 below.

TABLE 1

| File location | Parameters added/modified |
|---|---|
| /etc/defaults/dhcp3-server | INTERFACES=”eth0” |
| /etc/network/interfaces | auto eth0 |

address 192.168.1.1
netmask 255.255.255.0
network 192.168.1.0
broadcast 192.168.1.255

| | |
|---|---|
| /etc/dhcp3/dhcpd.conf | authoritative; |

subnet 192.168.1.0 netmask
255.255.255.0 {

range 192.168.1.2
192.168.1.254;
option router 192.168.1.1;

}

After modifying the respective files as shown in Table 1, networking and DHCP server 108 may need to be restarted, in order to cause the above modifications to take effect, by using the following commands:

/etc/init.d/networking restart
/etc/init.d/dhcp3-server restart

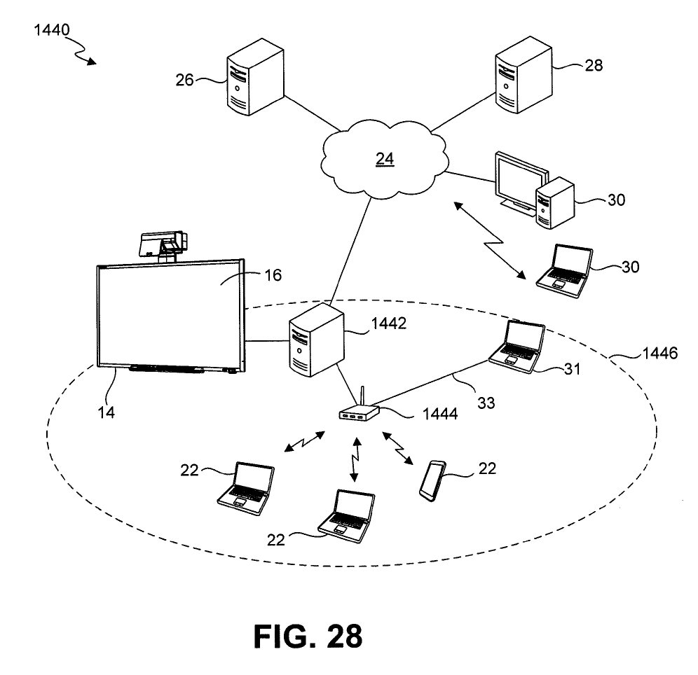

In other embodiments, the collaboration system may alternatively be capable of managing events in an organization that provides both wired and wireless connectivity. For example, FIG. 28 shows another embodiment of a collaboration system, which is generally indicated using reference numeral 1440. Collaboration system 1440 is generally similar to collaboration system 10 described above with reference to FIG. 1, and like elements of systems 10 and 1440 are indicated using like reference numerals. System 1440 comprises an event computing device 1442 that controls a network device 1444 providing both wired and wireless connections, and which establishes a network 1446. The network 1446 allows participant computing devices 22 and 31 to connect thereto and to join an event session. The wireless network portion of the network 1446 is controlled by the event computing device 1442, via the network device 1444, and is set up having a network SSID and a network key that are generated based on the event name and the event password using the method described above. The wired portion of the network 1446 allows a participant computing device 31 to be connected to the event computing device 1442 via an Ethernet cable and using RDP, as described above.

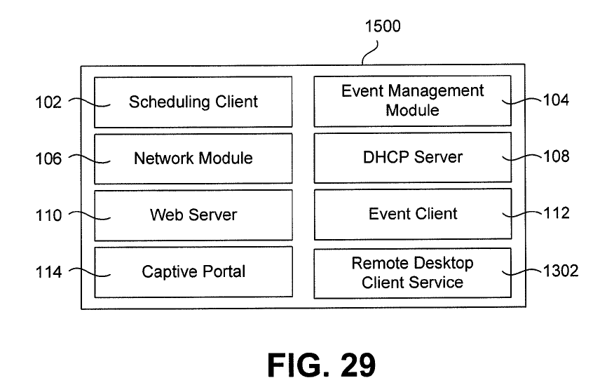

FIG. 29 shows the software architecture of the event computing device 1442, and which is generally indicated by reference numeral 1550. The software architecture 1500 is generally a combination of the software architectures 100 and 1300 described above with reference to FIGS. 2 and 26, respectively, and comprises a scheduling client 102, an event management module 104, a network module 106, a DHCP server 108, a web server 110, an event client 112, a captive portal module 114 and a remote desktop service 1302. These modules are generally similar to, and are referred to using like reference numerals, as those referred to in FIGS. 2 and 26.

The event management module 104 on the event computing device 1442 is configured to connect the event computing device 1442 to an event session, and to generate a wireless network name based on the event name. Once the wireless network name has been generated, the event management module 104 is configured to instruct wireless the network device 1444 to set the SSID of the wireless network portion of network 1446 as the generated wireless network name.

Advantageously, event computing device 1442 is configured to detect whether a wired connection has been established with participant computing device 31 via Ethernet cable 33, and if so, to assign a new IP address to participant computing device 31 using DHCP server 108. After a new IP address has been assigned, the event computing device 1442 invokes the remote desktop client service 1302 (with the newly assigned IP address as a parameter thereof), to share the desktop of the participant computing device 31 to IWB 14, and to enable the user of IWB 14 to interact with content in participant computing device 31, as described above with reference to the collaboration system 1200 shown in FIG. 24. In this embodiment, the participant computing device 31 joins the same network 1446 as the computing devices 22. However, in other embodiments, the event computing device 1442 may alternatively create a private network different from network 1446 when the participant computing device 31 is connected thereto.

In other embodiments, wireless network device 1444 may be integrated into, and form a part of, the event computing device 1442.

In other embodiments, at least some of the event computing devices 1202 shown in FIG. 1 or at least some of the event computing devices 1442 shown in FIG. 28 are not connected to an IWB 14. Instead, they are connected to other types of displays such as for example CRT monitors, LCD screens or projectors.

Although in embodiments described above, the collaboration system comprises an IWB having a generally vertical interactive surface, in other embodiments, the collaborative system may alternatively comprise an interactive device, such as for example a touch table, that has a horizontal interactive surface. In still other embodiments, the system may alternatively comprise an interactive device having an interactive surface positioned at any orientation suitable for an event.

In other embodiments, the DHCP server may be replaced with a network management module having an alternative protocol (e.g., Bootstrap Protocol (BOOTP)). When a participant computing device connects to the network, the network management module dynamically selects a network address (e.g. an IP address) from a pool of addresses maintained by a network configuration server, and assigns the selected network address to the participant computing device.

Although in embodiments described above, the collaboration system comprises one or more participant computing devices 30 connecting to the network 24, in other embodiments, the collaboration system may alternatively not comprise any participant computing devices 30.

Although in embodiments described above, the scheduling server sends notification to the event site that it needs to be vacated for an upcoming event, where the notification is a message sent by the scheduling server to the event computing device at the event site to display a notifications message on the IWB located therein, in other embodiments, other notifications may alternatively be used. For example, in other embodiments in which the collaboration system comprises an event room controller, the scheduling server may send notification to the event room controller to cause at least one light source in the event room to flash intermittently, lighting in the event room to be adjusted to a predefined level, and/or a speaker in the event room to emit one or more sounds.

Although in embodiments described above, the event client instructs the network client running on the participant computing device to obtain a list of available wireless networks matching the generated wireless network name, in other embodiments, the event client may instruct the network client running on the participant computing device to obtain a list of available wireless networks matching only a portion of the generated wireless network name. For example, if the generated wireless network name is “Product Demo”, but no wireless network having this name is found, the event client may then generate a list of available wireless networks with names that comprise the name “Product”. In still other embodiments, other matching criteria may be used. For example, the event client may instruct the network client running on the participant computing device to obtain a list of available wireless networks with names that comprise the same event room name.

Although in embodiments described above, the event session is terminated using an event end process, in other embodiments, the event session may alternatively be terminated automatically at a scheduled end time of the event.

Although in the embodiments shown in FIGS. 1, 19 and 28, an event client is stored in the event computing device 12 or the network management server 932, respectively, for participant computing devices to download, in some alternative embodiments, no event client is stored in the event computing device 12 or the network management server 932. In these embodiments, at least some event content, e.g., shared screen images, files, audio/video clips, digital ink annotations, links, schedules, etc., is provided to participants via a web interface hosted in the web server 110 or 988. A participant computing device that does not have an event client installed thereon may still join the event session through the wireless network as described above. When the participant computing device joins the event session, the participant computing device can launch a web browser. As described above, the captive portal 114 or 992 directs web requests to the web interface to allow the participant to access the event content.

The collaboration system described above may be used to facilitate a variety of events. For example, in some embodiments, the collaboration system may be used for facilitating scheduled or ad-hoc meetings. Meeting participants who have the event client on their computing devices may run the event client to join the event session via wired or wireless connections, as well known in the art. Meeting participants who do not have the event client on their computing devices may join the event session by connecting to the appropriate wireless network or by using the wired connection 33 as described above.

As another example, in some alternative embodiments, the collaboration system may be used for facilitating classroom activities. When an instruction or collaboration session starts, the collaboration system sets the SSID and network key by using the ID and password of the instruction session (which is either manually set up by the instructor or automatically set up based on a predefined instruction schedule, depending on the implementation and system configuration). A student may join an instruction session using aforementioned methods. When the instruction session terminates (e.g., under the instructor's command or at the scheduled instruction session termination time), the collaboration system resets the SSID and network key to the ID and password of the upcoming instruction session, or, if no instruction session is scheduled to start, resets the SSID and network key to a randomly generated ID and password.

In an alternative embodiment, the collaboration system maintains a list of registered participant computing devices. Depending on the implementation, this list may be stored in a database, an XML file, a plain text file, or in other appropriate forms. A user may register a computing device in the collaboration system, e.g., by associating the physical address such as for example the Media Access Control (MAC) address of the computing device with the respective user identity (e.g., user ID) and registering the MAC address and the associated user identity to the list of registered participant devices.

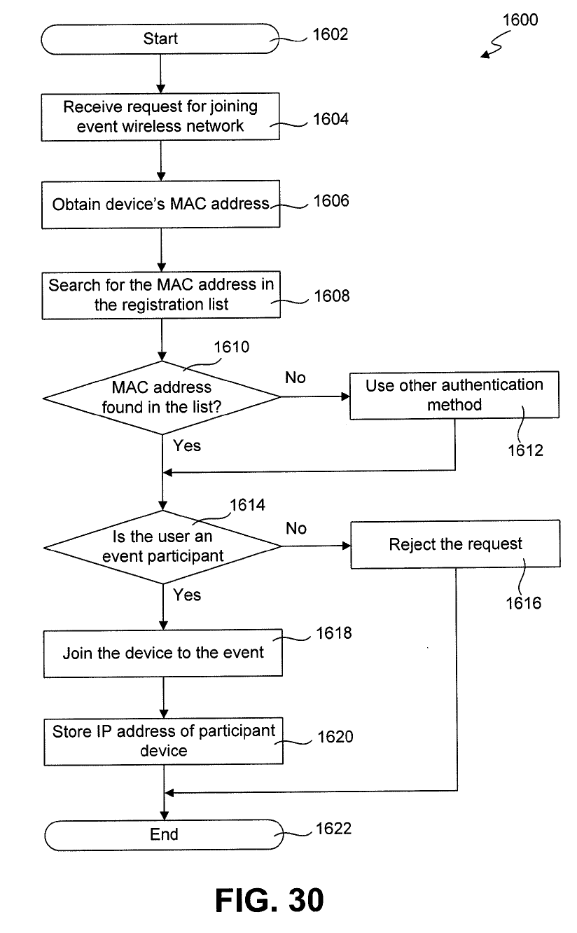

The collaboration system uses the list of registered participant devices to join a participant computing device into an event session without asking for the event password. FIG. 30 shows an exemplary process 1600 of joining a registered participant computing device into an event session.

The process 1600 starts when an event session and the wireless network associated therewith are started (step 1602). The user of a registered computing device searches for a wireless network associated with the event session as described above, and, after finding it, sends a request to join the event wireless network. The network module of the event computing device receives the request (step 1604), and obtains the computing device type and identity, e.g., the MAC address, of the computing device (step 1606). The event computing device then searches for the obtained MAC address in the list of registered computing devices (step 1608). At step 1610, if the MAC address is found, the process proceeds to step 1614; otherwise if the MAC address is not found (i.e., the participant computing device is not registered in the list), the collaboration system then uses another authentication method to authenticate the computing device, e.g., by asking the user to provide a password or passphrase (step 1612).

At step 1614, the collaboration system checks to determine if the user of the participant computing device is an invitee of the event session by using the MAC address obtained at step 1610 or the authentication result obtained at step 1612. If it is determined that the user of the computing device is not an invitee of the event session, the collaboration system rejects the request so that the participant computing device is excluded from accessing the event wireless network (step 1616). The process then ends (step 1622).

If, at step 1614, it is determined that the user of the participant computing device is an invitee of the event session, the collaboration system joins the participant computing device to the event session by granting the computing device access to the event wireless network (step 1618). As a part of the access-granting process, an IP address is assigned to the participant computing device. The collaboration system associates the IP address with the participant's user identity, and stores the IP address and the associated user identity (step 1620). The process then ends (step 1622).

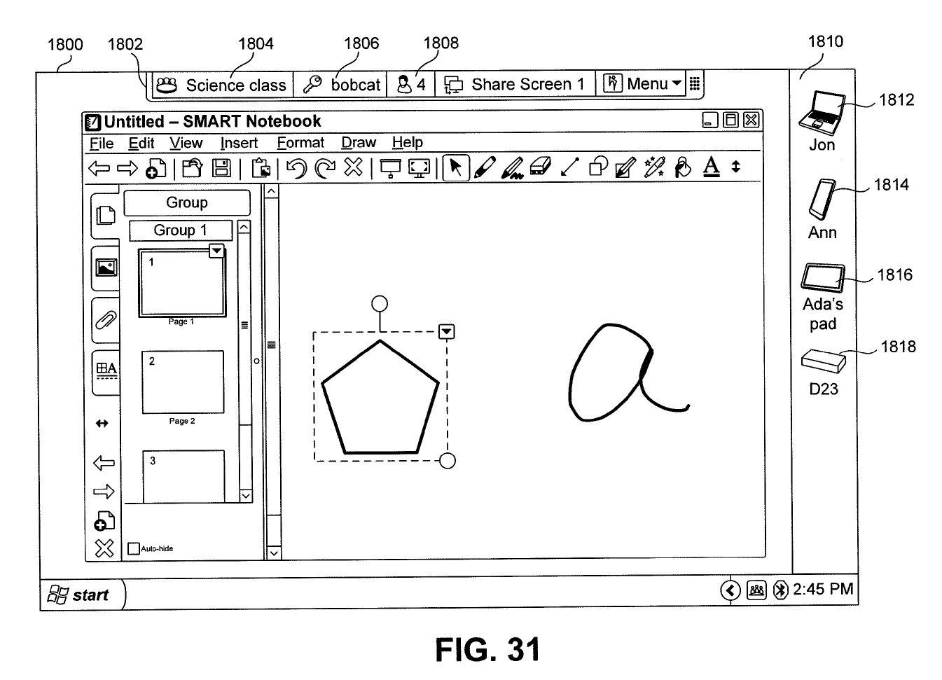

In this embodiment, the event computing device displays the participant computer devices and the user identities associated therewith. FIG. 31 shows an image 1800 presented on the display of the event computing device. The image 1800 comprises a top bar 1802 showing the event name 1804, password 1806, and the number 1808 of participant computing devices currently in the event session. The image 1800 also comprises a side bar 1810 showing the participant computing devices 1812 to 1818 that are currently in the event session, of which participant computing devices 1812 and 1814 joined the event session with authenticated user identities via the process shown in FIG. 30, and participant computing devices 1816 and 1818 joined the event session by providing correct event passwords/passphrases. Each participant computing device 1812 to 1818 is represented by a thumbnail image indicating its device type. Each participant computing device 1812, 1814 joining to the event session with an authenticated user identity is also represented by a user identifier (e.g., user's first name) representing the user identity associated with the participant computing device. Each participant computing device 1816 and 1818 joining to the event session by providing a correct event password/passphrase is represented by its device name.

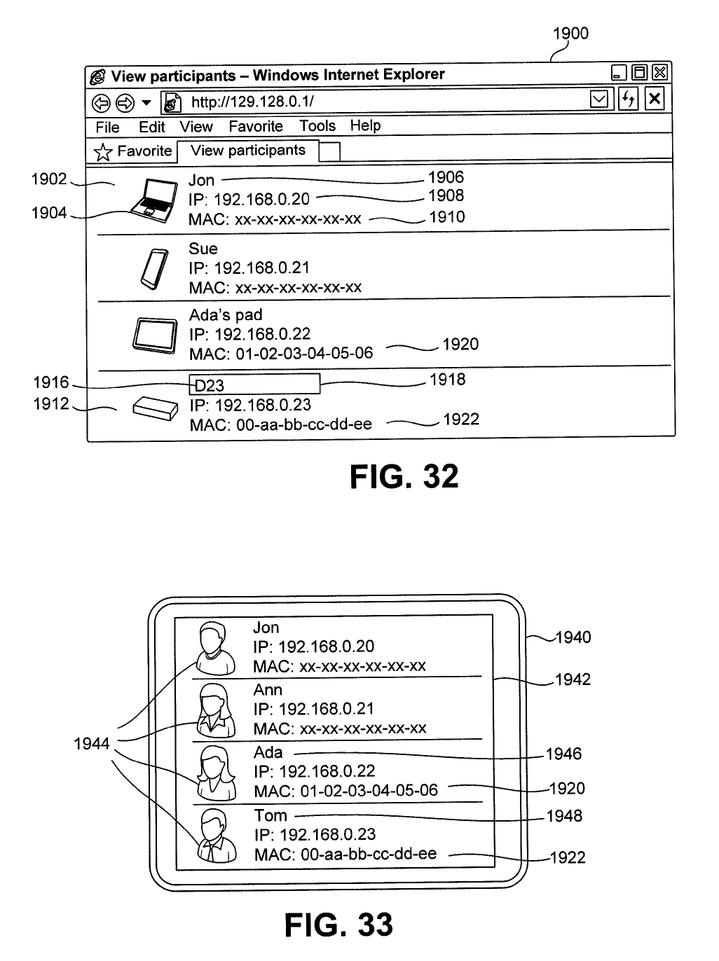

The web server in the event computing device also provides a webpage for authorized users, e.g., the event organizer or administrator, to view details of participant computing devices. FIG. 32 shows a web browser 1900 displaying the details of participant computing devices in a list of records, with each record comprising a thumbnail image representing the type of the device, a user identifier, the IP address assigned to the device and the device identity. For example, record 1902 comprises a thumbnail image 1904 representing the type of the device (a laptop computer), user identifier 1906 (e.g., first name), IP address 1908, and the device identity 1910, e.g., the MAC address. Of course, those skilled in the art will appreciate that other information of participant computing devices may also be shown, and any other appropriate user interface may be used to display the details of participant computing devices.

The authorized user may click or tap on the user identifier to modify it. For example, in FIG. 32, the record 1912 shows that the participant computing device is associated with a less meaningful user identifier 1916. The authorized user may click on the user identifier 1916 to invoke an editing mode of this field, e.g., a text input box 1918, and modify the user identifier 1916. The modified user identifier is then stored in the collaboration system, and is used for representing the participant computing device thereafter in any event session.

The authorized user may click or tap on the thumbnail image to change it to a different presentation, e.g., a picture of the user. FIG. 33 shows a portable participant computing device 1940 joined to the event session and displaying in a graphic user interface 1942, the details of participant computing devices, after an authorized user has modified thumbnail images and user identifiers of participant computing devices. In this example shown, the thumbnail images have been changed to pictures of the respective users. The user identifier 1946 associated with the participant computing device 1920 (identified by its MAC address 01-02-03-04-05-06 or IP address 192.168.0.22) has been changed from “Ada's pad” to “Ada”, and the user identifier 1948 associated with the participant computing device 1922 (identified by its MAC address 00-aa-bb-cc-dd-ee or IP address 192.168.0.23) has been changed from “D23” to “Tom”.

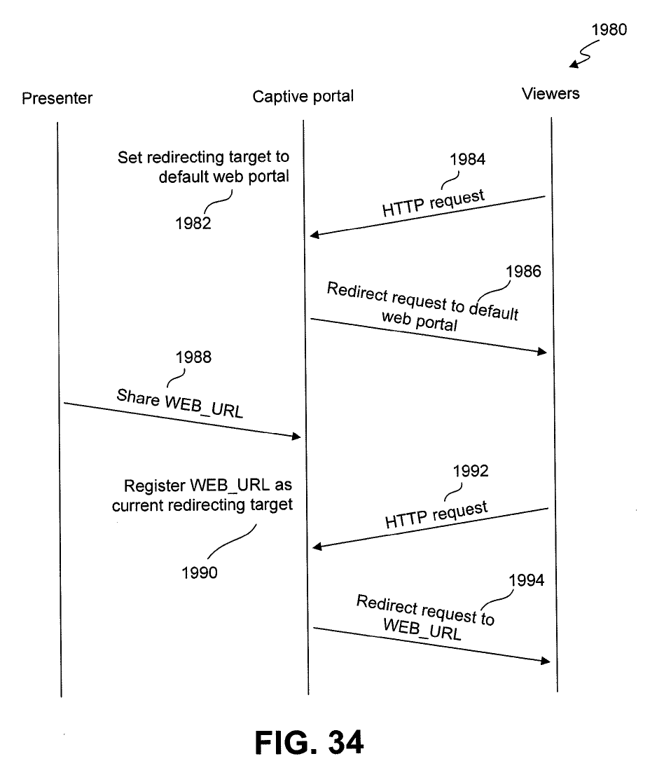

In a related embodiment, the collaboration system provides a dynamic captive portal to allow participants to share web content. FIG. 34 shows an exemplary sequence diagram 1980 for sharing a web URL. As shown, when the collaboration system starts, the captive portal first sets the redirecting target (i.e., the target location to which HTTP requests will be redirected) to a default web portal predefined in the collaboration system (step 1982). As described before, when any of the viewers (e.g., students) in the instruction session sends an HTTP request (step 1984), the captive portal intercepts and redirects the HTTP request to the current redirecting target, i.e., the default web portal (step 1986).

A presenter (e.g., an instructor) may send a sharing command to the captive portal to share a web location WEB_URL, e.g., “http://www.smarttech.com” (step 1988). After receiving the sharing command, the captive portal registers WEB_URL as the current redirecting target (step 1990). Thus, when any of the viewers (e.g., students) in the instruction session sends an HTTP request (step 1992), the captive portal intercepts and redirects the HTTP request to the current redirecting target, i.e., the web location WEB_URL (step 1992). As a result, viewers trying to access any website are redirected to the web location WEB_URL.

In another related embodiment, the captive portal may recognize participant computing devices used by a subset of users (via MAC address or IP address), and not redirect any HTTP request sent therefrom. The subset of users may be predefined or defined by system administrator.

In yet another related embodiment, the collaboration system provides a webpage-sharing bookmarklet for participants to easily share a webpage. As those skilled in the art will understand, a bookmarklet is a bookmark of a web browser that comprises a piece of script code such as for example a piece of JavaScript code. A participant may select the webpage-sharing bookmarklet, e.g., by clicking or tapping the webpage-sharing bookmarklet button in the bookmark toolbar, to execute the script code, which sends the address of the webpage currently shown in the browser to the captive portal, and instructs the captive portal to set it as the redirecting target.

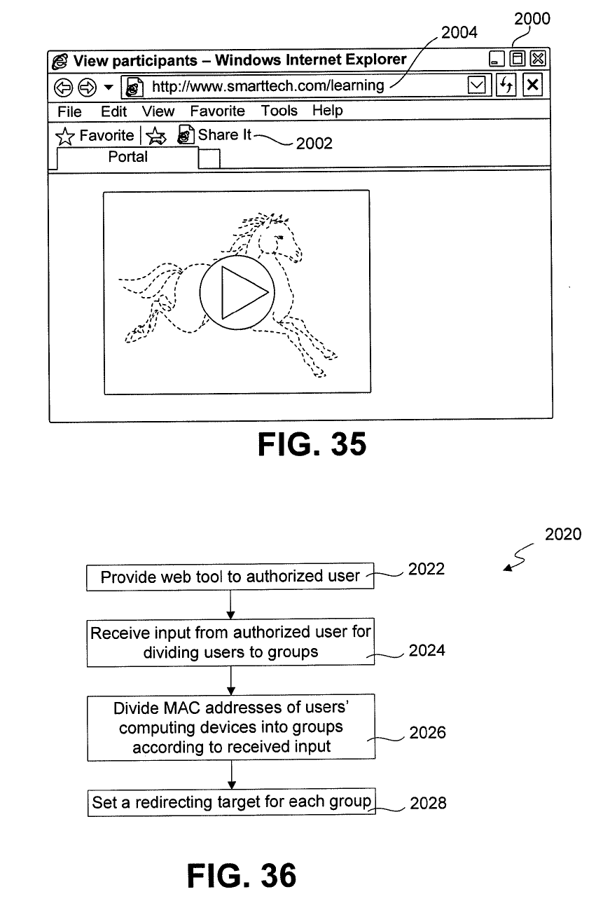

FIG. 35 shows an example of a web browser 2000 comprising a bookmarklet “Share It” 2002. While the participant is browsing a website 2004 and wants to share it with other people in the collaboration session, the participant clicks the “Share It” bookmarklet 2002 to execute the script code thereof in the web browser 2000. The script code then sends the address of the current webpage “http://www.smarttech.com/learning” to the captive portal. The captive portal upon receipt of the web address sets it as the redirecting target. As a result, when any participant sends an HTTP request, the captive portal redirects the request to the shared web address.

In another embodiment, the collaboration system allows participants to share their own content to other participants via a web browser. In this embodiment, the default web portal includes a file sharing tool implemented using appropriate technologies such as for example HTML5. The file sharing tool allows a participant to drag and drop a file into the web browser, or select a file via a dialog. The user-selected file is then uploaded to the web server, and the captive portal redirects HTTP requests from other participants to the URL of the uploaded file.

In yet another embodiment, the collaboration system allows the authorized user to divide participants in the collaboration session into groups. FIG. 36 is a flowchart 2020 showing steps of dividing participants into groups. When the process starts, the web server provides a web tool for the authorized user to divide participants into groups (step 2022). The authorized user is the able to access the web tool and set up groups. The web server in turn receives input from authorized user (step 2024), and based on the user input, divides the MAC addresses of participant computing devices into groups (step 2026). The captive portal then sets a redirecting target for each group (step 2028). In this embodiment, the redirecting target is set to the same default web portal for all groups.

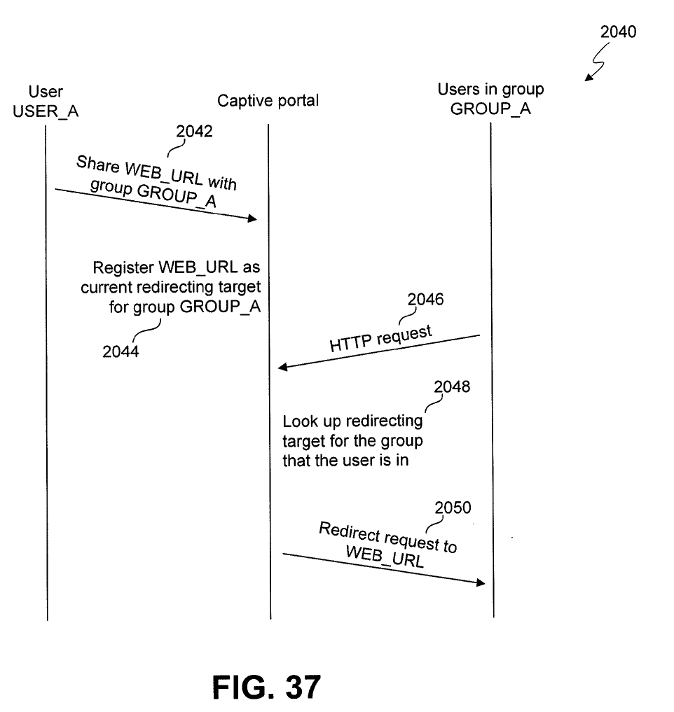

After dividing participants into groups, the authorized user may share different content to different groups. A participant of a group may also share content to other participants in the same group. FIG. 37 is an exemplary sequence diagram 2040 for sharing a web location WEB_URL within a participant group, GROUP_A.

A participant USER_A, who may be the authorized user such as the instructor, or a participant in group GROUP_A, sends a command to the captive portal to share a web location WEB_URL in group GROUP_A (step 2042). The captive portal then registers WEB_URL as the current redirecting target for group GROUP_A (step 2044). When any of the participants in group GROUP_A sends an HTTP request (step 2046), the captive portal intercepts the HTTP request, and obtains the information of the sender (step 2048). Then, the captive portal determines the group that the sender is in by using the sender information (e.g., IP address), which in this example is GROUP_A, and determines the redirecting target of the group, which in this example is WEB_URL (step 2048). The captive portal then redirects the HTTP request to WEB_URL (step 2050).

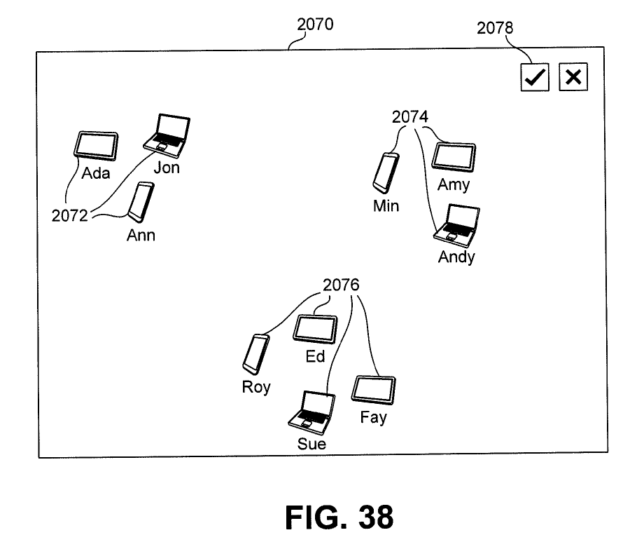

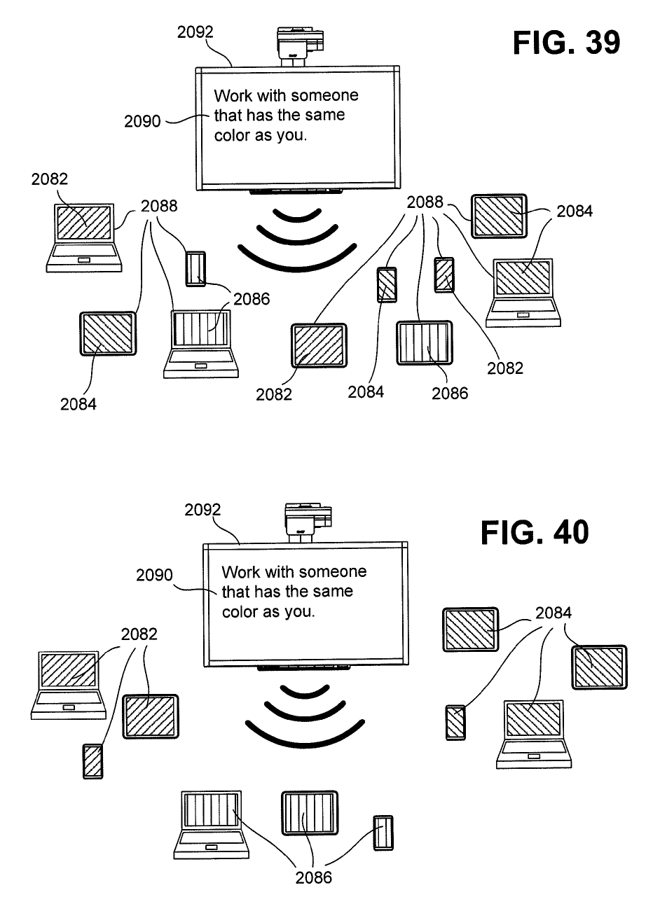

FIGS. 38 to 40 show an example of dividing participants to groups. As shown in FIG. 38, the collaboration system provides a grouping tool to the authorized user, e.g., an instructor, for setting up groups. The grouping tool displays in its window 2070, icons 2072, 2074 and 2076 of all computing devices in the collaboration session. The authorized user is able to drag icons 2072, 2074 and 2076 to different locations in window 2070 to form a plurality of groups. After the authorized user has completed computing device grouping and clicked on the confirmation button 2078, the grouping information is submitted to the captive portal. The captive portal then divides the MAC addresses of the computing devices into groups based on the authorized user's submission. Shown in FIG. 39, the captive portal assigns a distinct color 2082, 2084 and 2086 for each group, and sets a redirecting target for each group, which causes the browser of each computing device 2088 in the collaboration session to show the color 2082, 2084 or 2086 (represented in FIG. 39 by different shadings) assigned to the group to which that computing device belongs. The captive portal also causes the event computing device (not shown) to display a message 2090 on the IWB 2092. As shown in FIG. 40, the participants in the collaboration session may, with the help of the message 2090 displayed on the IWB 2092, find people in their group and start to work together.

In some related embodiments, the collaboration system also comprises a logging software module that records user activities. For example, the logging software module may record, for each time the authorized user shares content, which participant computing devices in the collaboration session have been redirected to the shared content, and which ones have not. As another example, the logging software module may record how frequently participants are sharing contents. As all Internet activities of the computing devices in the collaboration session go through the captive portal, the collaboration system may also record the words and phrases participants in the collaboration session have searched for, and generate a tag cloud of most searched terms for displaying on the IWB.

The collaboration system described above allows authorized users to implement various functions and activities. For example, an authorized user may add an “Eyes to the Front” bookmarklet to the browser running on the event computing device or their computing device. When the authorized user selects the “Eyes to the Front” bookmarklet, the script of the bookmarklet instructs the captive portal to redirect all HTTP requests to a reminder page reminding participants in the collaboration session to stop browsing websites and focus on the presentation of the authorized user. As another example, an authorized user may use the collaboration system to create a web-based quiz, which is hosted in the web server. When the authorized user starts the web-based quiz, the captive portal redirects any HTTP requests to the web address of the quiz to allow participants to take the quiz.

In an alternative embodiment, the collaboration system comprises a web-based whiteboarding software tool providing a whiteboard canvas extendable within its two-dimensional plane, such as the whiteboarding software tool disclosed in U.S. patent application Ser. No. 13/738,355, entitled “Method of Displaying Input During a Collaboration Session and Interactive Board Employing the Same,” to Tse, et al., filed on Jan. 11, 2012, assigned to SMART Technologies ULC, the disclosure of which is incorporated herein by reference in its entirety. In this embodiment, the captive portal redirects HTTP requests to the address of the web-based whiteboarding tool to allow participants in the collaboration session to work together. When participants in the collaboration session are divided into groups, each group is assigned to an individual whiteboarding session in the web-based whiteboarding tool, and the captive portal redirects the HTTP requests from each group to the respective whiteboarding session in the web-based whiteboarding tool.

Those skilled in the art will appreciate that a collaboration system as described above may comprise more than one event computing device in an event site. The event computing devices in the collaboration system may be in various fotins such as a desktop computer having an IWB, an IWB with a computing device integrated therein, a computing device in the form of a touch sensitive table, a computer with a non-touch-sensitive display, a laptop, etc.

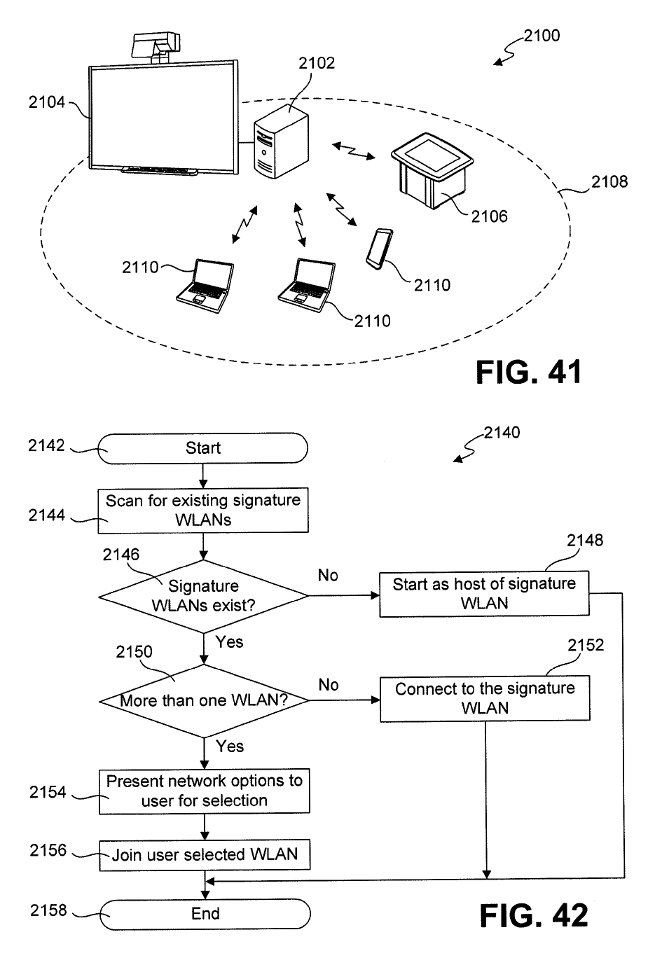

FIG. 41 shows a schematic diagram of a collaboration system 2100 according to an alternative embodiment. The collaboration system 2100 comprises event computing devices 2102 and 2106, each functionally connecting to a wireless networking component (not shown) that may serve as an Access Point (AP). In this embodiment, the wireless networking component is integrated into the event computing devices 2102 and 2106. However, the wireless networking component may of course be an independent device physically separated by functionally coupled to the respective event computing device.

In this embodiment, event computing device 2102 connects to an IWB 2104, and event computing device 2106 is in the form of a touch-sensitive table. As will be described later, one of the event computing devices, e.g., event computing device 2102, creates a “signature” wireless network 2100, and other event computing devices join the signature wireless network 2100. Participant computing devices 2110 may also join the signature wireless network using methods as described before. Although not shown in this figure, event computing devices 2102 and 2106, as well as the wireless network 2100, may be connected to servers and other networks such as for example, the Internet or a local area network within an organization, as described before.

The signature wireless network refers to a wireless network having a predefined “signature”, i.e., a predefined feature identifiable by computing devices within the range thereof. Multiple signature wireless networks with different SSIDs may have the same signature, and same vendor identity. Usually the signature is embedded in the signal of the wireless network that is detectable by the computing devices within range.

Each of the event computing devices 2102 and 2106, when started, detects if one or more signature wireless networks have been established, and determines whether to set up a signature wireless network based on the detection. FIG. 42 is a flowchart showing steps performed during an event computing device start up process 2140.

After an event computing device starts, the event computing device uses its wireless networking component to scan for existing signature wireless networks (step 2144). If no signature wireless network is detected (step 2146), the event computing device then starts a signature wireless network by using a default SSID and a randomly generated password/passphrase, and becomes the host computing device of the signature wireless network (step 2148). The process then ends (step 2158).

If at step 2146, the event computing device detects a signature wireless network, it further checks to determine if more than one wireless networks exist (step 2150). If only one signature wireless network exists, the event computing device then automatically retrieves the SSID and password of the detected signature wireless network from the signal thereof (described later), and connects to the detected signature wireless network using the retrieved SSID and password (step 2152). The process then ends (step 2158).

If at step 2150, the event computing device detects two or more wireless networks (e.g., two or more wireless networks of which only one wireless network has a signature matching that of the event computing device), the event computing device presents to user a list of detected signature wireless networks, and requests user to select which wireless network the event computing device should join (step 2154). The event computing then automatically retrieves the SSID and password of the user-selected signature wireless network from the signal thereof, and joins the user-selected wireless network (step 2156), and the process ends (step 2158).

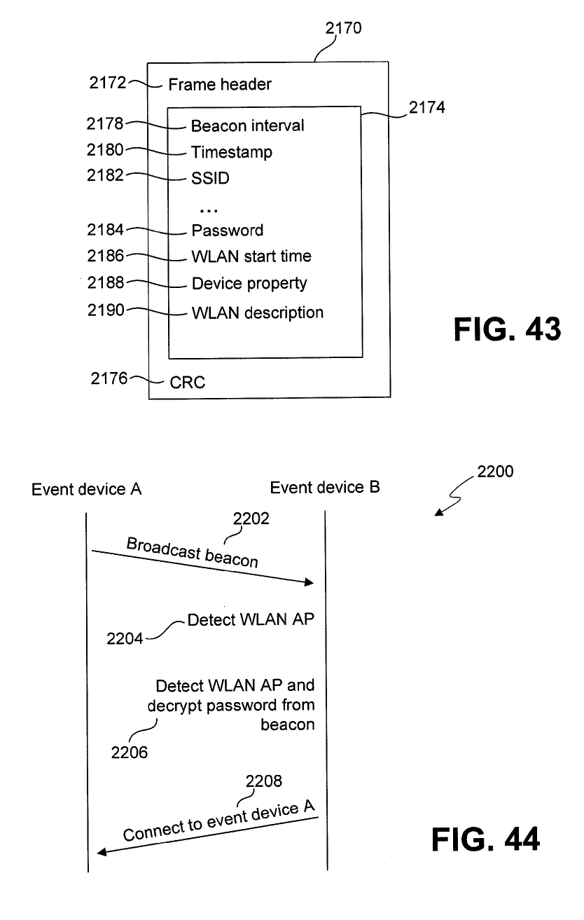

In this embodiment, the host computing device embeds the password of the signature wireless network in the beacon signal it broadcasts to all computing devices within the range of its wireless network. FIG. 43 shows an exemplary structure of a beacon signal frame 2170. As can be seen, each beacon signal frame comprises a frame header 2172, a frame body 2174 and a cyclic redundancy check (CRC) section 2176.

The frame body 2174 comprises a plurality of fields, including a beacon interval field 2178, which is used by a computing device that enters power saving mode to determine when to wake up and receive the beacon signal; a timestamp field 2180 for computing devices to synchronize their local clock; the SSID field 2182 comprising the SSID of the wireless network; as well as other fields, as defined in relevant standards, e.g., IEEE 802.11. The frame body 2174 also comprises a password field 2184 comprising the password for the wireless network, encrypted in a manner that only the event computing devices can decrypt. Those skilled in the art will appreciate that many existing encryption technologies may be used for encrypting the password embedded in the password field 2184, for example, by using an encryption method with an encryption code known to all event computing devices, or by using a public-key cryptography technology (e.g., PGP) with a public key known to all event computing devices.

For resolving race conditions (described further herein), the frame body 2174 comprises a WLAN start time field 2186 comprising a timestamp indicating the start time of the wireless network. The frame body 2174 also comprises a device property field 2188 indicating one or more properties of the event computing device, such as for example, the “signature”, the device type (e.g., an IWB device or a touch table), etc., and a WLAN description field 2190 comprising a brief description of the signature wireless network.

FIG. 44 is an exemplary sequence diagram 2200 illustrating an event computing device B joining the signature wireless network started by another event computing device A.

After event computing device A starts a signature wireless network following the steps shown in FIG. 42, the event computing device A, as the host of the signature wireless network, periodically broadcasts the beacon signal comprising beacon frames as described above (step 2202). When another event computing device B at a location within the range of the signature wireless network starts, event computing device B detects the signature wireless network (step 2204). Then, event computing device B retrieves the information in received beacon frames, and decrypts the password of the signature wireless network therefrom using the known encryption key or public key, depending on the implementation (step 2206). The event computing device B then communicates with event computing device A and joins the signature wireless network using the SSID and password obtained from the beacon signal (step 2208).

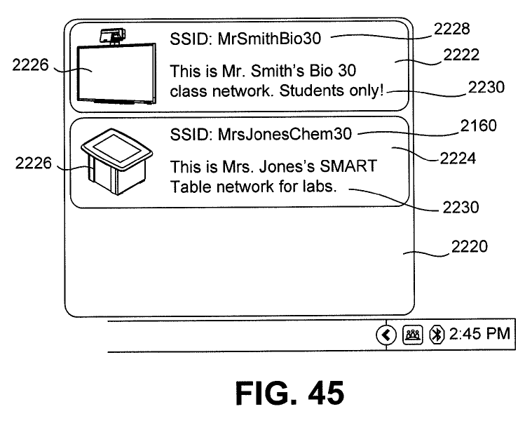

FIG. 45 illustrates an exemplary dialog 2220 that the event computing device displays to enable the user to select a signature wireless network. As shown, the event computing device lists all detected signature wireless networks 2222 and 2224 in the dialog 2220. Each entry 2222, 2224 comprises information obtained from the fields in the frame body 2174 of the beacon frames 2170 of the respective signature wireless network, for example, an icon 2226 indicating the device type of the host computing device, the SSID 2228 and the WLAN description 2230. The user may tap or click on an entry 2222 or 2224 to select the signature wireless network to join.

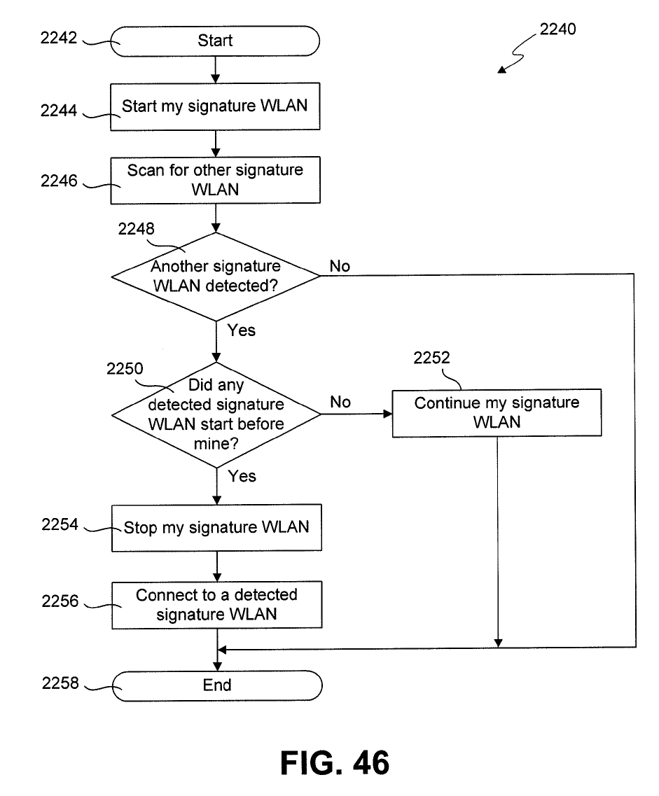

As described above, if the event computing device does not detect any existing signature wireless network, the event computing device sets up a signature wireless network. In situations where two event computing devices start at about the same time, both may determine that no signature wireless network exists, and therefore, both may set up their own signature wireless network (referred to as a race condition). To solve this issue, in some embodiments, each event computing device executes a race condition solving algorithm after starting its signature wireless network. FIG. 46 is a flowchart 2240 showing steps for solving race conditions.

The process starts after the event computing device has determined that no signature wireless network is detected (step 2242). After the event computing device first starts a signature wireless network (step 2244), the event computing device scans for other signature wireless networks (step 2246). If no other signature wireless network is found (step 2248), the process ends (step 2258).

If at step 2248, one or more other signature wireless networks are found, the event computing device retrieves the WLAN start time data 2186 from the beacon signal of respective wireless networks, and checks to determine if any of the detected signature wireless networks was started earlier than the signature wireless network the event computing device started (step 2250). If no other signature wireless network was started earlier, the event computing device continue hosting the signature wireless network (step 2252) and the process then ends (step 2258).

If at step 2250, one or more signature wireless networks were started earlier, the event computing device then stops the signature wireless network it has started (step 2254), and connects to a detected signature wireless network (step 2256). As described above, if there exists only one other signature wireless network, the event computing device then automatically joins the detected signature wireless network and if there are two or more other signature wireless networks, the event computing device then asks the user to make a selection, and joins the user-selected wireless network. Then process then ends (step 2258).

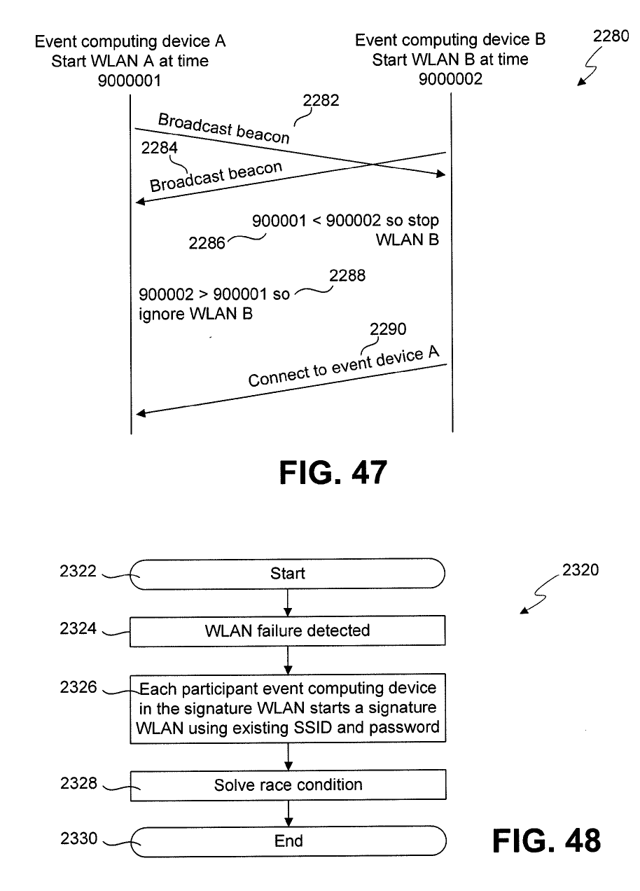

FIG. 47 is an exemplary sequence diagram 2280 of a race condition being solved. As shown, event computing devices A and B start at about the same time. As neither event computing device detects any existing signature wireless network, both event computing devices A and B start a respective signature wireless network WLAN A and WLAN B. However, event computing device A started the signature wireless network WLAN A at a timestamp 9000001 earlier than the signature wireless network WLAN B started by event computing device B at timestamp 9000002.

After starting the signature wireless network, event computing device A periodically broadcasts its beacon signal for the signature wireless network WLAN A (step 2282). Event computing device B also periodically broadcasts its beacon signal for the signature wireless network WLAN B (step 2284). When event computing device B receives the beacon signal from event computing device A, event computing device B retrieves the WLAN start time data therefrom. Since the WLAN start timestamp 9000001 in the beacon signal from event computing device A is earlier than the start timestamp 9000002 of WLAN B, event computing device B stops its signature wireless network WLAN B (step 2286).

At the same time, event computing device A also receives the beacon signal from event computing device B. Event computing device A retrieves the WLAN start time data therefrom. Since the WLAN start timestamp 9000002 in the beacon signal from event computing device B is later than the start timestamp 9000001 of WLAN A, event computing device A ignores the signature wireless network WLAN B (step 2288).

After stopping the signature wireless network WLAN B, event computing device B then connects to event computing device A using the SSID and password retrieved from the beacon signal for signature wireless network WLAN A, and joins the signature wireless network WLAN A (step 2290).

In some embodiments, the collaboration system allows an event computing device in a signature wireless network to recover the wireless network when the original host computing device thereof has failed. FIG. 48 is a flowchart 2320 showing steps of recovering a failed signature wireless network.

The process starts when an event computing device joins a signature wireless network hosted by an event computing device (step 2322). Each event computing device in the signature wireless network monitors the status of the wireless network by periodically checking the beacon signal broadcasted by the host event computing device. A wireless network failure is detected when the event computing devices no longer receive the beacon signal from the host event computing device (step 2324). When the wireless network failure has been detected, each event computing device automatically starts a signature wireless network using the same SSID and password of the failed wireless network (step 2326), and solves any race condition using the method described above (step 2328). The process then ends (step 2330).

Although in the above description, an event computing device, when started, detects whether a signature wireless network exists, and automatically joins a detected signature wireless network, or starts a signature wireless network if no signature wireless network is detected, in an alternative embodiment, some event computing devices may always start a signature wireless network regardless of whether any signature wireless network exists. In another embodiment, some event computing devices may only be allowed to join a signature wireless network.

Those skilled in the art will appreciate that an event computing device may join a wireless network with no signature or a wireless network with a different signature.

Although embodiments have been described above with reference to the accompanying drawings, those of skill in the art will appreciate that variations and modifications may be made without departing from the scope thereof as defined by the appended claims.

What is claimed is:

1. A method of establishing a collaborative event, said method comprising:
creating an event session having an event identifier; and
setting up a wireless network to which one or more participant computing devices can connect having a network identifier associated with said event identifier.

2. The method of claim 1, further comprising:
prior to creating said event session, collecting event information relating to said collaborative event.

3. The method of claim 2, wherein said event information comprises the event identifier and an event password.

4. The method of claim 3, further comprising:
communicatively coupling at least one participant computing device to said wireless network.

5. The method of claim 4, further comprising:
upon coupling of said at least one participant computing device to said wireless network, automatically causing said at least one participant computing device to join said event session.

6. The method of claim 5, further comprising:
providing said event identifier and said event password to said at least one participant computing device prior to coupling of said at least one participant computing device to said wireless network.

7. The method of claim 6, wherein said providing further comprises:
sending an electronic invitation message comprising said event identifier and said event password to said at least one participant computing device.

8. The method of claim 6, wherein said providing further comprises:
displaying said event identifier and said event password on a display at an event site of said collaborative event.

9. The method of claim 8, wherein said displaying is carried out on an interactive surface.

10. The method of claim 3, wherein said network identifier is derived from said event identifier by string manipulation.

11. The method of claim 10, wherein said string manipulation comprises concatenating at least a portion of said event identifier with additional characters.

12. The method of claim 3, further comprising:
setting a network key of said wireless network as said event password.

13. The method of claim 2, further comprising:
generating at least one of the event identifier and an event password based on the event information.

14. The method of claim 13, further comprising:
communicatively coupling at least one participant computing device to said wireless network.

15. The method of claim 14, further comprising:
upon coupling of said at least one participant computing device to said wireless network, automatically causing said at least one participant computing device to join said event session.

16. The method of claim 15, further comprising:
providing said event identifier and said event password to said at least one participant computing device prior to said coupling of said at least one participant computing device to said wireless network.

17. The method of claim 16, wherein said providing further comprises:
sending an electronic invitation message comprising said event identifier and said event password to said at least one participant computing device.

18. The method of claim 16, wherein said providing further comprises:
displaying said event identifier and said event password on a display at an event site of said collaborative event.

19. The method of claim 18, wherein said displaying is carried out on an interactive surface.

20. The method of claim 13, wherein said network identifier is derived from said event identifier by string manipulation.

21. The method of claim 20, wherein said string manipulation comprises concatenating at least a portion of said event identifier with additional characters.

22. The method of claim 13, further comprising:
setting a network key of said wireless network as said event password.

23. A non-transitory computer-readable medium having embodied thereon a computer program for a collaborative event, said program comprising instructions which, when executed by processing structure, carry out the steps of:
creating an event session having an event identifier; and
setting up a wireless network to which one or more participant computing devices can connect having a network identifier associated with said event identifier.

24. An interactive whiteboard configured to communicate with processing structure conducting a collaborative event, said interactive whiteboard further being configured, during said collaborative event, to display:
an event identifier of an event session of said collaborative event;
an event password of said event session; and
content shared between said processing structure and at least one participant computing device communicatively coupled to said event session.

25. The interactive whiteboard of claim 24, wherein said shared content comprises:
a common screen image shared by said processing structure and said at least one participant computing device.

26. The interactive whiteboard of claim 25, wherein said shared content further comprises:
annotations made to said shared content during said event session.

27. The interactive whiteboard of claim 26, wherein said annotations comprise at least one of touch input and digital ink input on said interactive whiteboard.

28. A computerized method comprising:
receiving, from a user computing device, information concerning the location of content to be shared;
intercepting a network request from another user computing device; and
redirecting the intercepted network request to the location of said content.

29. The method of claim 28, wherein said information is a sharing command directed to a portal configured to intercept network requests.

30. The method of claim 29, wherein said sharing command comprises a web universal source locator and wherein said network request is an HTTP request.

31. The method of claim 28, wherein said information is generated by a web browser running on said user computing device.

32. The method of claim 31, wherein said information is generated by a webpage-sharing bookmarklet of said web browser.

33. A computerized method comprising:
determining member participant computing devices of each group of participant computing devices;
intercepting a network request from one of said participant computing devices;
determining the group to which the participant computing device that sent the intercepted network request belongs; and
redirecting said the intercepted network request to a location assigned to said group.

34. The method of claim 33, wherein network requests from participant computing devices of different groups that are intercepted, are redirected to different locations.

35. The method of claim 34, wherein the network requests are HTTP requests and wherein each location is a different web URL.

36. A method comprising:
initiating, by a host computing device, a wireless network; and
broadcasting, by the host computing device, a signal comprising the identity of said wireless network and a password for accessing said wireless network.

37. The method of claim 36, wherein said signal is a beacon signal broadcast within the range of said wireless network.

38. The method of claim 37, further comprising:
extracting the identity and password from said signal; and
using the extracted identity and password to connect a participant computing device to the wireless network.

39. The method of claim 36, further comprising encrypting the password in said signal.

40. The method of claim 36, further comprising:
resolving race conditions when more than one wireless network is initialized.

41. The method of claim 40 wherein said resolving comprises:
after initializing said wireless network, determining if a signal has been generated by another computing device signifying the existence of another wireless network;
if so, comparing a timestamp representative of a creation time of the initiated wireless network, with a timestamp in the generated signal to determine the earlier created wireless network; and
maintaining only the earlier created wireless network.

42. An apparatus comprising:
processing structure;
wireless networking component functionally coupled to said processing structure, wherein said processing structure executes code that causes said apparatus at least to:
determine whether a wireless network having a predefined feature exists; and
start a wireless network if the wireless network having a predefined feature is not detected.

43. The apparatus of claim 42, wherein said processing structure further executes code that causes the apparatus to:
join a detected wireless network if at least one wireless network having said predefined feature is detected.

44. A method comprising:
initiating, by a host computing device, a first wireless network;
detecting a signal broadcasted by another computing device, said signal comprising a timestamp indicating the starting time of a second wireless network;
comparing said timestamp with the start time of said first wireless network; and
terminating said first wireless network if said timestamp indicates a time earlier than the start time of said first wireless network.

45. A non-transitory computer readable medium embodying executable code, that when executed by a computing device causes the computing device to perform the steps of:
receiving, from a user computing device, information concerning the location of content to be shared;
intercepting a network request from another user computing device; and
redirecting the intercepted network request to the location of said content.

46. A non-transitory computer readable medium embodying executable code, that when executed by a computing device causes the computing device to perform the steps of:
determining member participant computing devices of each group of participant computing devices;
intercepting a network request from one of said participant computing devices;
determining the group to which the participant computing device that sent the intercepted network request belongs; and
redirecting said the intercepted network request to a location assigned to said group.
